(19) United States
(12) Patent Application Publication
(10) Pub. No.: US 2011/0298361 A1
(43) Pub. Date: Dec. 8, 2011

(54) OPTICAL MEMBER, AND ORGANIC ELECTROLUMINESCENCE DISPLAY DEVICE PROVIDED WITH THE OPTICAL MEMBER

(76) Inventors: Atsushi Matsunaga, Kanagawa (JP); Ryuji Saneto, Kanagawa (JP); Yukito Saitoh, Kanagawa (JP); Tatsuho Nomura, Kanagawa (JP)

(21) Appl. No.: 13/202,532

(22) PCT Filed: Jan. 28, 2010
(86) PCT No.: PCT/JP2010/051542

§ 371 Date: Aug. 19, 2011

(30) Foreign Application Priority Data
Feb. 20, 2009 (JP) 2009-038684

(51) Int. Cl. H01J 1/62; G02B 5/02

(52) U.S. Cl. 313/504; 359/599

(57) ABSTRACT

An optical member according to the present invention includes a transparent substrate provided with a barrier layer, a low-refractive-index layer, and a light diffusion layer, the transparent substrate, the low-refractive index layer and the light diffusion layer being provided in this order, wherein the light diffusion layer includes a light scattering particle and a matrix material containing at least a binder resin, the light scattering particle being dispersed in the matrix material, wherein the low-refractive-index layer has a thickness of 1.2 m or more, and wherein the optical member is used in organic electroluminescence display devices.

### TECHNICAL FIELD

The present invention relates to an optical member capable of improving light emission efficiency of an optical electroluminescence display device and to an organic electroluminescence display device provided with the optical member.

### BACKGROUND ART

The organic electroluminescence display device (otherwise referred to as “organic EL display device”) is a self-emission type display device and used for the purpose of display or lighting. The organic EL display has an advantage in view of display performance, such as high visibility in comparison with conventional CRT or LCD or no viewing angle dependency, and is also advantageous in that the display can be lightweighted or thinned. On the other hand, the organic EL lighting has a possibility that lighting in a heretofore unrealizable shape can be realized by using a flexible substrate, in addition to the advantage such as lightweighting or thinning.

The organic EL display device or inorganic EL display device has excellent properties, but the refractive index of each of layers constituting the display device, including a light emitting layer, is higher than that of air. For example, in an organic EL display device, the refractive index of an organic thin-film layer such as light emitting layer is from 1.6 to 2.1. Therefore, the light emitted readily causes total reflection or interference at the interface and the light extraction efficiency is less than 20%. Thus, the majority of light is lost.

This light loss in an organic EL display device is reviewed by referring to FIG. 1. The organic EL display device is fundamentally fabricated such that, as shown in FIG. 1, a back electrode 2, an organic layer 3 composed of two or three layers including a light emitting layer, a transparent electrode 4 and a transparent substrate 5 are stacked on a TFT substrate 1, and a hole injected from the back electrode 2 and an electron injected from the transparent electrode 4 are recombined in the organic layer 3 to excite a fluorescent substance or the like, whereby light is emitted. The light emitted from the organic layer 3 is output from the transparent substrate 5 directly or after being reflected from the back electrode 2 formed of aluminum or the like.

However, as shown in FIG. 1, light generated inside the display device causes total reflection depending on the angle of light incident on the interface with an adjacent layer differing in the refractive index, and the light is entirely waveguided through the inside of the display device and cannot be extracted to the outside (light of Lb and Lc in FIG. 1). The percentage of this waveguided light is determined by the refractive index relative to the adjacent layer, and in the case of a general organic EL display device (air (n=1.0)/transparent substrate (n=1.5)/transparent electrode (n=2.0)/organic layer (n=1.7)/back electrode), the percentage of light which is not released to the atmosphere (air) but is waveguided through the inside of the display devices becomes about 81%. That is, only about 19% of the entire light emission quantity cannot be effectively utilized.

Accordingly, the measures required for enhancing the light extraction efficiency are: (a) to extract light totally reflected from the transparent substrate/air interface and waveguided through the “organic layer+transparent electrode+transparent substrate” (Lb in FIG. 1); and (b) to extract light totally reflected from the transparent electrode/transparent substrate interface and waveguided through the “organic layer+transparent electrode” (Lc in FIG. 1).

Out of these measures, with respect to (a), a method of preventing total reflection from the transparent substrate/air interface by forming irregularities on the transparent substrate surface has been proposed (see, for example, Patent Literature 1).

With respect to (b), a method of processing the transparent electrode/transparent substrate interface or light emitting layer/adjacent layer interface to have a diffraction grating has been proposed (see, for example, Patent Literatures 2 and 3). Also, a method of increasing the light emission efficiency by processing the interface between stacked organic layers to have irregularities has been proposed (see, for example, Patent Literature 4). For example, in the method of forming a diffraction grating at the light emitting layer/adjacent layer interface, the adjacent layer is composed of an electrically conductive medium, the depth of irregularities of the diffraction grating is about 40% based on the film thickness of the light emitting layer, and the pitch and depth of irregularities are set to be in a specific relationship, whereby the waveguided light is extracted. In the method of forming irregularities at the interface between organic layers, the adjacent layers across irregularities are each composed of an electrically conductive medium, and irregularities having a depth of about 20% based on the film thickness of the light emitting layer and a tilt angle of about 30° with respect to the interface are formed at the interface between organic layers to enlarge the interface at which the organic layers are joined together, whereby the light emission efficiency is increased.

However, these methods have such a problem as that the processing is difficult or dielectric breakdown readily occurs at the time of passing a current. In order to elevate the efficiency of the light-emitting display device, further development of a useful method for extracting light is demanded.

As one of the means for solving these problems, for example, a technique of providing a light scattering layer on the surface of an organic EL surface light emitter to improve the extraction efficiency has been proposed (see, for example, Patent Literatures 5 to 9). However, occurrence of light scattering on the surface brings about a problem that light is greatly blurred and resolution degrades. Note that although the electroluminescence element of Patent Literature 8 is provided with a low-refractive-index layer, the method has such a problem as that image blurring cannot be prevented due to its insufficient light extraction efficiency.

### CITATION LIST

### Patent Literature

[PTL 1] U.S. Pat. No. 4,774,435
[PTL 2] Japanese Patent Application Laid-Open (JP-A) No. 11-283751
[PTL 3] Japanese Patent Application Laid-Open (JP-A) No. 2002-313554
[PTL 4] Japanese Patent Application Laid-Open (JP-A) No. 2002-313567
[PTL 5] Japanese Patent Application Laid-Open (JP-A) No. 2003-109747
[PTL 6] Japanese Patent Application Laid-Open (JP-A) No. 2003-173877
[PTL 7] Japanese Patent Application Laid-Open (JP-A) No. 11-329742
[PTL 8] Japanese Patent Application Laid-Open (JP-A) No. 2004-296437
[PTL 9] U.S. Patent No. 2009-0015142

### SUMMARY OF INVENTION

### Technical Problem

The present invention aims to solve the above conventional problems and to achieve objects described below. That is, an object of the present invention is to provide an optical member capable of improving light extraction efficiency of an organic electroluminescence display device and reducing image blurring, and to provide an organic electroluminescence display device provided with the optical member. In particular, an object of the present invention is to provide an optical member capable of improving light extraction efficiency of an optical electroluminescence display device wave-guiding “organic layer+transparent electrode” and reducing image blurring, and to provide an organic electroluminescence display device provided with the optical member.

### Solution to Problem

Means for solving the above problems are as follows:

<1> An optical member including:
a transparent substrate provided with a barrier layer,
a low-refractive-index layer, and
a light diffusion layer,
the transparent substrate, low-refractive index layer and light diffusion layer being provided in this order,
wherein the light diffusion layer contains a light scattering particle and a matrix material containing at least a binder resin, the light scattering particle being dispersed in the matrix material,

wherein the low-refractive-index layer has a thickness of 1.2 μm or more, and

wherein the optical member is used in organic electroluminescence display devices.

<2> The optical member according to <1>, wherein the light diffusion layer further contains a colorant and functions as a color filter.
<3> The optical member according to one of <1> and <2>, wherein the light scattering particle contains at least one inorganic fine particle selected from ZrO₂, TiO₂, ZnO, and SnO₂.
<4> The optical member according to any one of <1> to <3>, wherein the light scattering particle has a refractive index of 2.1 or higher, and the matrix material has a refractive index of 1.6 or lower.
<5> The optical member according to any one of <1> to <4>, wherein the light scattering particle has an average particle diameter of 2.0 μm or smaller.
<6> The optical member according to <5>, wherein the light scattering particle has an average particle diameter of 0.2 μm to 0.5 μm.
<7> The optical member according to any one of <1> to <6>, wherein the light diffusion layer has a thickness of 2.0 μm to 10.0 p.m.
<8> The optical member according to any one of <1> to <7>, wherein the low-refractive-index layer has a refractive index of 1.45 or lower.
<9> The optical member according to <8>, wherein the low-refractive-index layer contains a hollow silica.
<10> An organic electroluminescence display device including:

the optical member according to any one of <1> to <9>.

<11> The organic electroluminescence display device according to <10>, further including an adhesion layer, wherein the adhesion layer has a refractive index of 1.5 to 1.9.
<12> The organic electroluminescence display device according to <11>, wherein the adhesion layer has a refractive index of 1.65 to 1.9.
<13> The organic electroluminescence display device according to one of <11> and <12>, wherein the adhesion layer has a thickness of 10 μm or less.

### Advantageous Effects of Invention

According to the present invention, it is possible to solve the above conventional problems, to achieve the above objects, and to provide an optical member capable of improving light extraction efficiency of an organic electroluminescence display device and reducing image blurring, and an organic electroluminescence display device provided with the optical member.

As described in the section of background art, a cause of the low light extraction efficiency in a self light-emitting display device is that light produced inside the display device causes a total reflection due to a large angle of light incident on an interface with an adjacent layer differing in the refractive index and the light is entirely waveguided through the inside of the display derive and cannot be extracted to the outside.

On the other hand, by introducing, in the organic EL display device, a light diffusion layer containing a binder resin and a light scattering particle, it is possible to extract the light to the outside. That is, the traveling direction of light caused to be waveguided through layers due to total reflection is bent by the action of light scattering, whereby light extraction to the outside can be realized.

At this time, by setting the refractive index of the matrix material (excluding the light scattering particle from the constituents of the light diffusion layer) to be equal to or higher than the refractive index of the organic light emitting layer, light being waveguided inside of a high refractive index layer including the organic light emitting layer can be extracted to the outside.

Also, at this time, by scattering light on the upper electrode, the distance between the light emitting point and the scattering position can be narrowed and the resolution of an image can be prevented from degrading due to light scattering. Furthermore, in order to more elevate the light extraction efficiency, it is preferred to increase the number of occurrences of light scattering. To this end, the number of occurrences of total reflection in a high refractive index layer including the organic light emitting layer is preferably increased, which can be realized by thinning the high-refractive-index layer including the organic light emitting layer.

In addition, the light extraction efficiency can also be enhanced by setting the refractive index of the matrix material to be lower than that of the organic light emitting layer and setting the refractive index of the light scattering particle to be equal to that of the organic light emitting layer. In this case, total reflection occurs at the interface between the upper electrode and the light diffusion layer, and the light scattering particle having a high refractive index is in contact with the interface to allow for occurrence of light scattering at the contact portion, so that light reflected by total reflection can be extracted to the outside.

### BRIEF DESCRIPTION OF DRAWINGS

FIG. 1 is a view illustrating a cause of reduction in light extraction efficiency in a self light-emitting display device.

FIG. 2 is a schematic diagram illustrating a basic configuration of an optical member according to the present invention.

FIG. 3 is a schematic diagram illustrating a basic configuration of an organic EL display device according to the present invention.

FIG. 4 is a diagram illustrating an evaluation method of image blur (first).

FIG. 5 is a diagram illustrating an evaluation method of image blur (second).

FIG. 6 is a diagram illustrating an evaluation method of image blur (third).

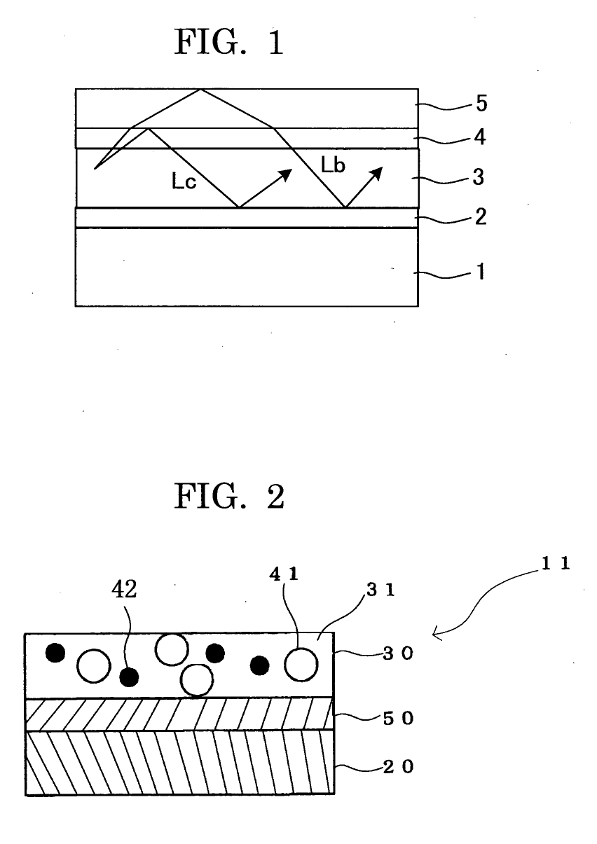

### DESCRIPTION OF EMBODIMENTS

### Optical Member

An optical member according to the present invention includes at least a transparent substrate provided with a barrier layer, a low-refractive-index layer and a light diffusion layer, and further includes other members as required.

FIG. 2 is a schematic diagram illustrating a basic configuration of the optical member of the present invention. In FIG. 2, an optical member 11 has a transparent substrate 20 provided with a barrier layer, a low-refractive-index layer 50 and a light diffusion layer 30 in this order. Not that the barrier layer (not illustrated) may be provided at least one surface of the transparent substrate provided with the low-refractive-index layer 50 and the opposite surface thereof.

<Transparent Substrate Provided with Barrier Layer>

The transparent substrate 20 provided with a barrier layer includes at least a transparent base film and a barrier layer, and further includes other layers as required. Examples of the other layers include a matting agent layer, a protective layer, a solvent resistant layer, an antistatic layer, a smoothing layer, an adhesion improving layer, a light shielding layer, a reflection preventing layer, a hard coat layer, a stress relaxation layer, an antifogging layer, an antifouling layer, a printed layer, and an easy-adhesion layer.

### <<Transparent Base Film>>

The transparent base film in the transparent substrate 20 provided with a barrier layer is not particularly limited and may be suitably selected in accordance with the intended use. For example, a transparent resin film, a transparent resin plate and a transparent resin sheet are exemplified.

The transparent resin film is not particularly limited and may be suitably selected in accordance with the intended use. Specific examples thereof include a triacetylcellulose (TAC) film (refractive index: 1.48), a polyethylene terephthalate (PET) film, a polyethylene naphthalate (PEN) film, a diacethylenecellulose film, an acetate butylate cellulose film, a polyether sulfone film, a polyacrylic resin film, a polyurethane resin film, a polyester film, a polycarbonate film, a polysulfone film, a polyether film, a polymethyl pentene film, a polyether ketone film, and a (meth)acrylonitrile film. The thickness of the transparent resin film is usually about 25 μm to about 1,000 μm.

The refractive index of triacetylcellulose used as a transparent base film is 1.48.

### <<Barrier Layer>>

The barrier layer is not particularly limited as long as it has a function to prevent transmission of oxygen, moisture, nitrogen oxides, sulfur oxides and ozone in air, and may be suitably selected in accordance with the intended use.

The material of the barrier layer may be a material having a function to prevent substances that accelerate degradation of the element, such as moisture and oxygen, from entering the element. Specific examples of the barrier layer include metals such as In, Sn, Pb, Au, Cu, Ag, Al, Ti, and Ni; metal oxides such as MgO, SiO, SiO₂, Al₂O₃, GeO, NiO, CaO, BaO, Fe₂O₃, Y₂O₃, and TiO₂, metal nitrides such as SiN; metal oxynitrides such as SiON; metal fluorides such as MgF₂, LiF, AlF₃, and CaF₂; copolymers of a dichlorodifluoroethylene with polyethylene, polypropylene, polymethylmethacrylate, polyimide, polyurea, polytetrafluoroethylene, polychlorotrifluoroethylene, polydichlorodifluoroethylene, or chlorotrifluoroethylene; copolymers obtained by copolymerization of tetrafluoroethylene with a comonomer mixture containing at least one comonomer; fluorine-containing copolymers having a cyclic structure in the copolymerization main chain, water-absorbing materials having a water-absorption rate of 1% or higher; and moisture resistant materials having a water absorption coefficient of 0.1% or lower.

The thickness of the barrier layer is not particularly limited and may be suitably selected in accordance with the intended use. It is however preferably 5 nm to 1,000 nm, more preferably 7 nm to 750 nm, particularly preferably 10 nm to 500 nm.

When the thickness of the barrier layer is less than 5 nm, the barrier function for preventing transmission of oxygen and moisture in air may be insufficient. When the thickness is more than 1,000 nm, the light transmittance may decrease, and the transparency of the transparent substrate may be impaired.

The light transmittance of the barrier layer is usually 80% or higher, preferably 85% or higher, more preferably 90% or higher.

The forming method of the barrier layer is not particularly limited and may be suitably selected in accordance with the intended use. Examples of the forming method include a vacuum evaporation method, sputtering method, reactive sputtering method, MBE (molecular beam epitaxy) method, cluster ion beam method, ion plating method, plasma polymerization method (high-frequency excitation ion plating method), plasma CVD method, laser CVD method, thermal CVD method, gas-source CVD method, and coating method.

### <Light Diffusion Layer>

The light diffusion layer contains at least a binder resin, a light scattering particle, a colorant, and further contains other components as required.

When the light diffusion layer is used to function as the after-mentioned color filter, the light diffusion layer contains a colorant.

For instance, as illustrated in FIG. 2, in the light diffusion layer 30, a light scattering particle 41 is dispersed in a matrix material 31 (portions of constituents of the light diffusion layer 30 from which the light scattering particle 41 is excluded), which contains a binder resin and a colorant 42. The light diffusion layer 30 may be composed of a plurality of layers. Further, as the light scattering particle 41, two or more types of particles may be used.

The light scattering profile and the haze value of the light diffusion layer 30 are controlled by controlling each refractive index the matrix material 31 and the light scattering particle 41 and the particle size of the light scattering particle 41.

The refractive index of the light scattering particle 41 in the light diffusion layer 30 is not particularly limited and may be suitably selected in accordance with the intended use. The refractive index of the light scattering particle 41 is however preferably 2.1 or higher, more preferably 2.15 or higher, particularly preferably 2.2 or higher, in terms that a difference in refractive index from the matrix material 31 is 0.05 or more and a sufficient amount of light scattering can be obtained. By setting the refractive index of the light diffusion layer 30 higher, it is possible to obtain an effect of further improving the light extraction efficiency.

The thickness of the light diffusion layer 30 is not particularly limited as long as it is about 0.5 μm to about 50 μm in dry film thickness, and may be suitably selected in accordance with the intended use. It is however preferably 1 μm to 20 μm, more preferably 2 μm to 10 particularly preferably 3 μm to 7 μm.

### <<Light Scattering Particle>>

The light scattering particle 41 is not particularly limited and may be suitably selected in accordance with the intended use. It is however preferred that a difference in refractive index from the matrix material 31 constituting the entirety of the light diffusion layer 30 be 0.02 or more. With the difference in refractive index being less than 0.02, the light scattering effect may not be obtained due to an excessively small difference in refractive index. In the present invention, in order to improve the light extraction efficiency, it is necessary to diffuse light totally reflected at the interface. The greater the light diffusion effect is, the more the light extraction efficiency improves.

As the light scattering particle 41, one type particle may be used alone or two or more types of particles may be used in combination.

The type of the light scattering particle 41 is not particularly limited and may be suitably selected in accordance with the intended use. The light scattering particle 41 may be an organic fine particle or may be an inorganic fine particle.

The organic fine particle is not particularly limited and may be suitably selected in accordance with the intended use. Examples thereof include polymethylmethacrylate beads, acryl-styrene copolymer beads, melamine beads, polycarbonate beads, styrene beads, crosslinked polystyrene beads, polyvinyl chloride beads, and benzoguanamine-melamine formaldehyde beads.

The inorganic fine particle is not particularly limited and may be suitably selected in accordance with the intended use. For example, SiO₂ (e.g., amorphous silica beads), ZrO₂, TiO₂, Al₂O₃, In₂O₃, ZnO, SnO₂, and Sb₂O₃, and the like are used.

The average particle diameter of the light scattering particle 41 is preferably 2.0 μm or smaller, more preferably 0.2 μm to 0.5 μm in terms that a sufficient light scattering amount is obtained and the directionality of light scattering is substantially isotropic scattering. By making light-scattering directionality close to isotropic scattering, a larger amount of light can be extracted.

Note that the above average particle diameter was determined as follows. First, a suspension liquid containing the light scattering particle at the time of preparing the matrix material, in which the light scattering particle was dispersed before forming the light diffusion layer, was passed through a particle size distribution analyzer to measure a particle size distribution. As the particle size distribution analyzer, a MICROTEC particle size distribution analyzer “9230 UPA” available from NIKKISO Co., Ltd. was used. From the measured particle size distribution, data of the particle diameter, frequency and accumulation rate was obtained. From the obtained data, a particle diameter was regarded as a diameter of a spherical-shaped particle, and the resulting number average particle diameter was determined as the average particle diameter of the light scattering particle.

In the case of the above-mentioned light scattering particle 41, the light scattering particle 41 easily precipitate in the matrix material 31. Therefore, an inorganic filler such as silica may be added thereto for preventing the precipitation. With increasing the addition amount of the inorganic filler, the effect of preventing precipitation of the light scattering particle 41 is increased, but more adversely affects the transparency of the coating film. Therefore, preferably, an inorganic filler having a particle diameter of 0.5 μm or smaller is incorporated into the matrix material 31, in an amount without impairing the transparency of the coating film, i.e., in an amount of less than 0.1% by mass.

### <<Binder Resin>>

The binder resin contained in the matrix material 31 is not particularly limited and may be suitably selected in accordance with the intended use. For example, acrylic copolymers are exemplified. Preferred is a polymer having a saturated hydrocarbon or a polyether in the main chain, and more preferred is a polymer having a saturated hydrocarbon in the main chain. Further, it is preferable that the binder resin be crosslinked. The polymer having a saturated hydrocarbon in the main chain is preferably obtained by a polymerization reaction of an ethylenically unsaturated monomer. In order to obtain a crosslinked binder resin, it is preferable to use a monomer having two or more ethylenically unsaturated groups.

The monomer having two or more ethylenically unsaturated groups is not particularly limited and may be suitably selected in accordance with the intended use. Specific examples thereof include esters of polyhydric alcohol with a (meth)acrylic acid (e.g., ethyleneglycol di(meth)acrylate, 1,4-dichlorohexane diacrylate, pentaerythritol tetra(meth)acrylate), pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, 1,3,5-cyclohexanetriol trimethacrylate, polyurethane polyacrylate, and polyester polyacrylate), derivatives of vinylbenzene (e.g., 1,4-divinylbenzene, 4-vinyl benzoate-2-acryloylethyl ester, and 1,4-divinylcyclohexanone), vinylsulfone (e.g., divinylsulfone), acrylamide (e.g., methylene bis acrylamide), and methacrylamide. Among these, an acrylate or a methacrylate monomer each having at least three functional groups, and an acrylate monomer having at least five functional groups are preferable in terms of film hardness, i.e., scratch resistance, with a mixture of dipentaerythritol pentaacrylate with dipentaerythritol hexaacrylate (commercial products) being more preferable. These monomers may be used in combination. In the present invention, the term “(meth)acrylate” means “acrylate or methacrylate”.

These monomers having an ethylenically unsaturated group can be cured by dissolving each of these monomers along with various polymerization initiators and other additives in a solvent to prepare a coating solution, applying the coating solution onto an object, followed by drying and subjecting to a polymerization reaction under application of light, ionizing radiation or heat.

A crosslinked structure may be introduced in the binder resin by a reaction of a crosslinkable functional group, instead of using the monomer having two or more ethylenically unsaturated groups or in addition to the monomer.

The crosslinkable functional group is not particularly limited and may be suitably selected in accordance with the intended use. Examples thereof include isocyanato group, epoxy group, aziridine group, oxazoline group, aldehyde group, carbonyl group, hydrazine group, carboxyl group, methylol group, and active methylene group. The crosslinkable functional group may be a functional group exhibiting crosslinkability as a result of decomposition reaction, like blocked isocyanato group. That is, the crosslinkable functional group may be a functional group that will not immediately exhibit reactivity but will exhibit its reactivity as a result of being decomposed. These binder resins having such a crosslinkable group can form a crosslinked structure by being heated after coating.

Meanwhile, the monomer for use in introducing the crosslinked structure is not particularly limited and may be suitably selected in accordance with the intended use. Examples thereof include vinyl sulfonic acid, acid anhydride, cyanoacrylate derivatives, melamine, etherified methylol, ester, urethane, and metal alkoxide such as tetramethoxysilane.

The matrix material 31 is preferably formed, in addition to the binder resin, of a monomer having a high-refractive index and/or a metal oxide ultrafine particle having a high-refractive index, and the like.

The monomer having a high-refractive index is not particularly limited and may be suitably selected in accordance with the intended use. Examples thereof include bis(4-methacryloylthiophenyl)sulfide, vinyl naphthalene, vinyl phenyl sulfide, and 4-methacryloxyphenyl-4′-methoxyphenyl thioether.

The metal oxide ultrafine particle having a high-refractive index is not particularly limited and may be suitably selected in accordance with the intended use. For example, fine particles composed of at least one metal oxide selected from zirconium (Zr), titanium (Ti), aluminum (Al), indium (In), zinc (Zn), tin (Sn) and antimony (Sb) and having a particle diameter of 100 nm or smaller are preferred, and more preferred are those fine particles having a particle diameter of 50 nm or smaller. Specific examples thereof are fine particles of ZrO₂, TiO₂, Al₂O₃, In₂O₃, ZnO, SnO₂, Sb₂O₃, ITO or the like. Among these fine particles, fine particles of ZrO₂ are more preferred.

The amount of the monomer having a high-refractive index and/or the metal oxide ultrafine particle having a high-refractive index added to the total mass of the matrix material 31 is preferably 10% by mass to 90% by mass, more preferably 20% by mass to 80% by mass.

When the matrix material 31 is in contact with the transparent base film in the transparent substrate 20 provided with a barrier layer, in order to simultaneously satisfy the exhibition of anti-glare property and the adhesion between a support and an anti-glare layer, a solvent for use in the coating liquid for forming the matrix material 31 is composed of at least one solvent that dissolves the transparent base film (e.g., triacetylcellulose support), and at least one solvent that does not dissolve the transparent base film. It is preferred that at least one of the solvents that do not dissolve the transparent base film have a higher boiling point than at least one of the solvents that dissolve the transparent base film. A difference in boiling point of a solvent having the highest boiling point among the solvents that do not dissolve the transparent base film from a solvent having the highest boiling point among the solvents that dissolve the transparent base film is preferably 30° C. or more, more preferably 50° C. or more.

The solvent that dissolves the transparent base film is not particularly limited and may be suitably selected in accordance with the intended use. Specific examples thereof include ethers having 3 to 12 carbon atoms (e.g. dibutylether, dimethoxymethane, dimethoxyethane, diethoxyethane, propylene oxide, 1,4-dioxane, 1,3-dioxolane, 1,3,5-trioxane, tetrahydrofuran, anisole, and phenatole); ketones having 3 to 12 carbon atoms (e.g. acetone, methylethylketone, diethyl ketone, dipropyl ketone, diisobutyl ketone, cyclopentanone, cyclohexanone, and methylcyclohexanone); esters having 3 to 12 carbon atoms (e.g., ethyl formate, propyl formate, n-pentyl formate, methyl acetate, ethyl acetate, methyl propionate, ethyl propionate, n-pentyl acetate, and γ-butyrolactone); and organic solvents having two or more functional groups (e.g., methyl 2-methoxyacetate, methyl 2-ethoxyacetate, ethyl 2-ethoxyacetate, ethyl 2-ethoxypropionate, 2-methoxy ethanol, 2-propoxy ethanol, 2-butoxy ethanol, 1,2-diacetoxyacetone, acetylacetone, diacetone alcohol, methyl acetoacetate, and ethyl acetoacetate). Among these, preferred are ketone solvents. These solvents may be used alone or in combination.

The solvent that does not dissolve the transparent base film is not particularly limited and may be suitably selected in accordance with the intended use. Specific examples thereof include methanol, ethanol, 1-propanol, 2-propanol, 1-butanol, 2-butanol, tert-butanol, 1-pentanol, 2-methyl-2-butanol, cyclohexanol, isobutyl acetate, methyl isobutyl ketone, 2-octanone, 2-pentanone, 2-hexanone, 2-heptanone, 3-pentanone, 3-heptanone, and 4-heptanone. These solvents may be used alone or in combination.

A mass ratio (A/B) of a total amount of the solvents (A) that dissolve the transparent base film to a total amount of the solvents (B) that do not dissolve the transparent base film is not particularly limited and may be suitably selected in accordance with the intended use. It is, however, preferably 5/95 to 50/50, more preferably 10/90 to 40/60, particularly preferably 15/85 to 30/70.

The material of the matrix material 31, in which the binder resin is contained, is not particularly limited and may be suitably selected in accordance with the intended use. Examples of the material include resins which are primarily cured by any one of ultraviolet ray, electron beam, and heating, i.e., photocurable resins, ionizing radiation-curable resins, and thermosetting resins. The material of the matrix material 31 may also be a mixture in which a thermoplastic resin and a solvent are mixed to these thermosetting resins.

As the curing method of the photocurable resins, typical curing methods for the photocurable resins are exemplified. In other words, the photocurable resins can be cured by irradiation of ultraviolet ray. As the curing method of the ionizing radiation-curable resins, typical curing methods for the ionizing radiation curable resins are exemplified. In other words, the ionizing radiation-curable resins can be cured by irradiation of electron beam.

For instance, in the case of curing with an electron beam, it is possible to use electron beams, etc. having energy of 50 keV to 1,000 keV, preferably 100 keV to 300 keV, generated from various types of electron beam accelerators, such as Cockroft-Walton type, Vandegraph type, resonance transformation type, insulated core transformer type, linear type, Dinamitron type, and high-frequency type. In the case of curing with an ultraviolet ray, it is possible to utilize ultraviolet rays from light emitted from a ultra-high pressure mercury lamp, high pressure mercury lamp, low pressure mercury lamp, carbon arc, xenon arc, metal halide lamp and the like.

### <<Colorant>>

The colorant is not particularly limited and may be suitably selected in accordance with the intended use. Examples of the colorant include high-molecular weight organic materials such as organic pigments, organic dyes, fullerene, polydiacetylene, and polyimide; and organic particles composed of an aromatic hydrocarbon or an aliphatic hydrocarbon (e.g., aromatic hydrocarbons or aliphatic hydrocarbons having orientation property, or aromatic hydrocarbons or aliphatic hydrocarbons having sublimation property). Among these, organic pigments, organic dyes, and high-molecular weight organic materials are preferable, with the organic pigments being more preferable. These organic particles may be used alone or in combination.

The organic pigments are not limited in terms of color phase. Examples of the organic pigments include perylene, perinone, quinacridone, quinacridonequinone, anthraquinone, anthanthorone, benzimidazolone, disazo condensates, disazo, azo, indanthrone, phthalocyanine, triarylcarbonium, dioxazine, aminoanthraquinone, diketopyrrolopyrrole, thioindigo, isoindoline, isoindolinone, pyranthrone, cyanine or isoviolanthrone compound pigments, and mixtures thereof.

Specific examples of the organic pigments include perylene compound pigments such as C.I. Pigment Red 190 (C.I. No. 71140), C.I. Pigment Red 224 (C.I. No. 71127) and C.I. Pigment Violet 29 (C.I. No. 71129); perinone compound pigments such as C.I. Pigment Orange 43 (C.I. No. 71105) and C.I. Pigment Red 194 (C.I. No. 71100); quinacridone compound pigments such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. No. 73900, 73906) and C.I. Pigment Red 209 (C.I. No. 73905); quinacridonequinone compound pigments such as C.I. Pigment Red 206 (C.I. No. 73900/73920), C.I. Pigment Orange 48 (C.I. No. 73900/73920) and C.I. Pigment Orange 49 (C.I. No. 73900/73920); anthraquinone compound pigments such as C.I. Pigment Yellow 147 (C.I. No. 60645); anthanthorone compound pigments such as C.I. Pigment Red 168 (C.I. No. 59300); benzimidazolone compound pigments such as C.I. Pigment Brown 25 (C.I. No. 12510), C.I. Pigment Violet 32 (C.I. No. 12517), C.I. Pigment Yellow 180 (C.I. No. 21290), C.I. Pigment Yellow 181 (C.I. No. 11777), C.I. Pigment Orange 62 (C.I. No. 11775) and C.I. Pigment Red 185 (C.I. No. 12516); disazo condensate compound pigments such as C.I. Pigment Yellow 93 (C.I. No. 20710), C.I. Pigment Yellow 94 (C.I. No. 20038), C.I. Pigment Yellow 95 (C.I. No. 20034), C.I. Pigment Yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262 and C.I. Pigment Brown 23 (C.I. No. 20060); disazo compound pigments such as C.I. Pigment Yellow 13 (C.I. No. 21100), C.I. Pigment Yellow 83 (C.I. No. 21108) and C.I. Pigment Yellow 188 (C.I. No. 21094); azo compound pigments such as C.I. Pigment Red 187 (C.I. No. 12486), C.I. Pigment Red 170 (C.I. No. 12475), C.I. Pigment Yellow 74 (C.I. No. 11714), C.I. Pigment Yellow 150 (C.I. No. 48545), C.I. Pigment Red 48 (C.I. No. 15865), C.I. Pigment Red 53 (C.I. No. 15585), C.I. Pigment Orange 64 (C.I. No. 12760) and C.I. Pigment Red 247 (C.I. No. 15915); indanthrone compound pigments such as C.I. Pigment Blue 60 (C.I. No. 69800); phthalocyanine compound pigments such as C.I. Pigment Green 7 (C.I. No. 74260), C.I. Pigment Green 36 (C.I. No. 74265), C.I. Pigment Green 37 (C.I. No. 74255), C.I. Pigment Blue 16 (C.I. No. 74100), C.I. Pigment Blue 75 (C.I. No. 741602), C.I. Pigment Blue 15:6 (C.I. No. 74160) and C.I. Pigment Blue 15:3 (C.I. No. 74160); triarylcarbonium compound pigments such as C.I. Pigment Blue 56 (C.I. No. 42800) and C.I. Pigment Blue 61 (C.I. No. 42765:1); dioxazine compound pigments such as C.I. Pigment Violet 23 (C.I. No. 51319) and C.I. Pigment Violet 37 (C.I. No. 51345); aminoanthraquinone compound pigments such as C.I. Pigment Red 177 (C.I. No. 65300); diketopyrrolopyrrole compound pigments such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71 and C.I. Pigment Orange 73; thioindigo compound pigments such as C.I. Pigment Red 88 (C.I. No. 73312); isoindoline compound pigments such as C.I. Pigment Yellow 139 (C.I. No. 56298) and C.I. Pigment Orange 66 (C.I. No. 48210); isoindolinone compound pigments such as C.I. Pigment Yellow 109 (C.I. No. 56284), C.I. Pigment Yellow 185 (C.I. No. 56290) and C.I. Pigment Orange 61 (C.I. No. 11295); pyranthrone compound pigments such as C.I. Pigment Orange 40 (C.I. No. 59700) and C.I. Pigment Red 216 (C.I. No. 59710); quinophthalone pigments such as C.I. Pigment Yellow 138; and isoviolanthrone compound pigments such as C.I. Pigment Violet 31(60010). Among these pigments, preferred are quinacridone compound pigments, diketopyrrolopyrrole compound pigments, dioxazine compound pigments, phthalocyanine compound pigments, and azo compound pigments, with the diketopyrrolopyrrole compound pigments, dioxazine compound pigments, and phthalocyanine compound pigments being more preferable.

The dispersibility and the dispersion stability of the colorant can be improved by using the colorant as a powdery processed pigment in which the colorant is finely dispersed in an acrylic resin, maleic resin, vinyl chloride-vinyl acetate copolymer, ethylcellulose resin or the like.

Next, the following describes the treating method of the pigment. In the present invention, it is preferable that the pigment be preliminarily treated with various types of resins. In other words, after a pigment is synthesized, the resulting pigment is generally died by various drying methods. Typically, a pigment is dispersed in an aqueous medium, dried and supplied in the form of a powder. Drying water requires a large amount of evaporation latent heat, and then a large amount of thermal energy is applied to the aqueous medium so as to be a dry powder. Therefore, it is usual that the pigment is formed of aggregates (secondary particles) in which primary particles aggregate to each other. It is not easy to disperse such a pigment formed of the aggregates in fine particles, and thus it is desired that the pigment be preliminarily treated with resins. Examples of the resins used here include the after-mentioned alkali soluble resins.

As the treatment method, there are flushing treatments and kneading methods using a kneader, extruder, ball mill, double- or triple roll mill or the like. Among these, flushing treatment and a kneading method using double- or triple roll mill are favorably used for forming fine particles.

The flushing treatment is a method in which a water-dispersion liquid containing a common pigment is mixed with a resin solution in which the resin has been dissolved in a water-immiscible solvent so as to extract the pigment into the organic medium from the aqueous medium, thereby treating the pigment with the resin. With this method, the pigment does not undergo drying, and thus aggregation of the pigment can be prevented, and the dispersion is easily carried out. Meanwhile, the kneading method using a double- or triple roll mill is a method in which a pigment and a resin or a resin solution are mixed, and the pigment and the resin are kneaded under application of a high-shearing force to coat a surface of the pigment with the resin, thereby treating the pigment. In the course of this treatment, aggregated pigment particles are dispersed from low-level aggregates to primary particles.

The pigment may also be used as a processed pigment which is preliminarily treated with an acrylic resin, vinyl chloride-vinyl acetate resin, maleic resin, ethylcellulose resin, nitrocellulose resin or the like. As the form of the processed pigment, preferred are a powder, a paste, and a pellet in each which a resin and a pigment are uniformly dispersed. Unfavorable one is an inhomogeneous agglomerate form in which the resin is gelled.

For the purpose of improving the dispersibility of the pigment, a conventionally known pigment dispersants and surfactants may be used in combination. The pigment dispersants and surfactants are not particularly limited and may be suitably selected in accordance with the intended use. Examples thereof include cationic surfactants such as phthalocyanine derivatives (EFKA-745 produced by EFKA), SOLSPERSE 5000 (produced by Zeneca Inc.); organosiloxane polymer KP341 (produced by Shin-Etsu Chemical Co., Ltd.), (meth)acrylic (co)polymers of POLYFLOW No. 75, No. 90 and No. 95 (produced by Kyoeisha Chemical Co., Ltd.), and W001 (produced by Yusho Co., Ltd.); nonionic surfactants such as polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, and sorbitan aliphatic acid ester; anionic surfactants such as W004, W005, W017 (produced by Yusho Co., Ltd.); polymer dispersants such as EFKA-46, EFKA-47, EFKA-47EA, EFKA POLYMER 100, EFKA POLYMER 400, EFKA POLYMER 401, and EFKA POLYMER 450 (produced by Morishita Sangyo K.K.), and DISPERSE AID 6, DISPERSE AID 8, DISPERSE AID 15, and DISPERSE AID 9100 (produced by San Nopco Co. Ltd.); various SOLSPERSE dispersants such as SOLSPERSE series of 3000, 5000, 9000, 12000, 13240, 13940, 17000, 24000, 26000, and 28000 (Zeneca Inc.); ADEKA PULRONIC L31, F38, L42, L44, L61, L64, F68, L72, P95, F77, P84, F87, P94, L101, P103, F108, L121, and P-123(Asahi Denka Kogyo K.K.), and ISONET S-20 (produced by Sanyo Chemical Industries, Ltd.).

### <Low-Refractive-Index Layer>

The low-refractive-index layer is not particularly limited as long as the layer has a thickness of 1.2 μm or more, and may be suitably selected in accordance with the intended use. When the thickness of the low-refractive-index layer is less than 1.2 μm, it is impossible to improve the light extraction efficiency of the organic electroluminescence and to reduce image blur.

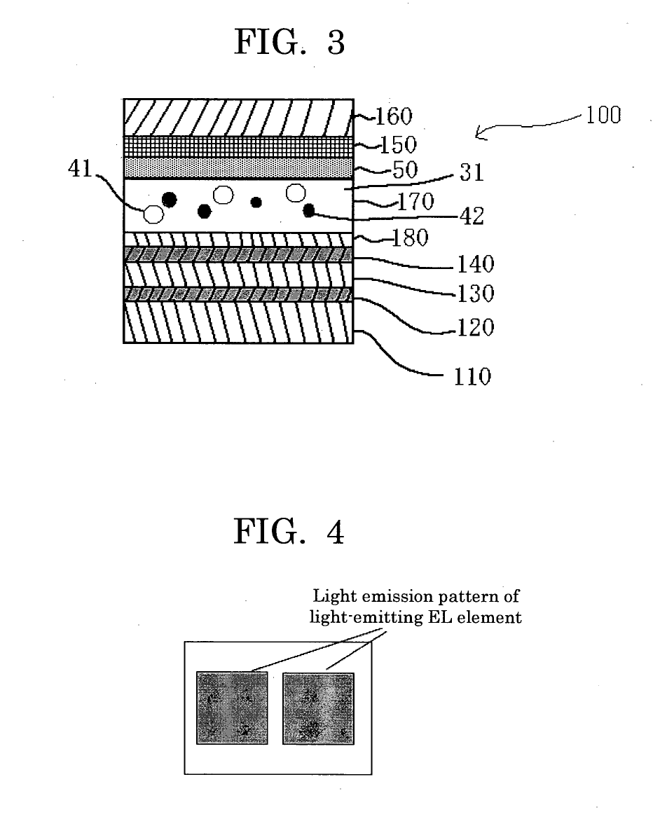

As illustrated in FIG. 3, the low-refractive-index layer 50 is provided in between the transparent substrate 20 provided with a barrier layer and the light diffusion layer 30, in order to impart a function of improving light extraction efficiency. The effect of improving light extraction efficiency from the low-refractive-index layer 50 can be obtained in combination with the light diffusion layer 30.

The thickness of the low-refractive-index layer 50 is preferably greater than a value of about λ/4 in that brightness nonuniformity due to coherence of light can be avoided.

The refractive index of the low-refractive-index layer 50 is not particularly limited and may be suitably selected in accordance with the intended use. It is, however, preferably 1.45 or lower, more preferably 1.30 to 1.45, in that a difference in refractive index from air is 0.45 or less, and a total reflection can be prevented.

The material of the low-refractive-index layer 50 is not particularly limited and may be suitably selected in accordance with the intended use. Examples thereof include fluorine-containing resins in which thermosetting or photocurable type crosslinkable fluorine-containing compound is cured.

A low-refractive-index layer using the fluorine-containing resin is superior in scratch resistance even when used as an outermost surface layer, as compared to a low-refractive-index layer using magnesium fluoride or calcium fluoride.

The refractive index of the thermosetting or photocurable type crosslinkable fluorine-containing compound is not particularly limited and may be suitably selected in accordance with the intended use. It is, however, preferably 1.30 to 1.45.

The coefficient of dynamic friction of the cured fluorine-containing resin is not particularly limited and may be suitably selected in accordance with the intended use. It is, however, preferably 0.03 to 0.15.

The contact angle of the cured fluorine-containing resin with respect to water is not particularly limited and may be suitably selected in accordance with the intended use. It is, however, preferably 90 degrees to 120 degrees.

Such a crosslinkable fluorine-containing compound is not particularly limited and may be suitably selected in accordance with the intended use. For example, perfluoroalkyl group-containing silane compounds (e.g., (heptadecafluoro-1,1,2,2-tetradecyl)triethoxysilane), and fluorine-containing copolymers having a structural unit of a fluorine-containing monomer with a monomer for giving a crosslinkable group.

The fluorine-containing monomer unit is not particularly limited and may be suitably selected in accordance with the intended use. Examples thereof include fluoroolefins (e.g., fluoroethylene, vinylidene fluoride, tetrafluoroethylene, hexafluoroethylene, hexafluoropropylene, perfluoro-2,2-dimethyl-1,3-dioxol, etc.), partially or completely fluorinated alkyl ester derivatives of (meth)acrylic acid (e.g., BISCOAT 6FM (produced by Osaka Organic Chemical Industry, Ltd.), and M-2020 (produced by Daikin Industries Ltd.), etc.), and completely or partially fluorinated vinyl ethers.

The monomer for giving a crosslinkable group is not particularly limited and may be suitably selected in accordance with the intended use. Examples thereof include (meth)acrylate monomers which preliminarily having a crosslinkable functional group in the molecule, like glycidyl methacrylate; and (meth)acrylate monomers having a carboxyl group, hydroxyl group, amino group, sulfonic acid group or the like (e.g., (meth)acrylic acid, methylol(meth)acrylate, hydroxyalkyl(meth)acrylate, allyl acrylate, etc.)). Japanese Patent Application Laid-Open (JP-A) Nos. 10-25388 and 10-147739 disclose that (meth)acrylate monomers having a carboxyl group, hydroxyl group, amino group, sulfonic acid group or the like is copolymerized and then a crosslinked structure can be introduced thereinto.

For the low-refractive-index layer 50, not only a copolymer of the fluorine-containing monomer with the monomer for giving the crosslinkable group, but also a polymer in which other monomer is copolymerized with the fluorine-containing monomer and the monomer for giving a crosslinking group, may be used. The other monomer is not particularly limited and may be suitably selected in accordance with the intended use. Examples thereof include olefins (ethylene, propylene, isoprene, vinyl chloride, vinylidene chloride, etc.), acrylic acid esters (methyl acrylate, ethyl acrylate, 2-ethylhexyl acrylate), methacrylic acid esters (methyl methacrylate, ethyl methacrylate, butyl methacrylate, ethylene glycol dimethacrylate, etc.), styrene derivatives (styrene, divinylbenzene, vinyl toluene, α-methylstyrene, etc.), vinyl ethers (methyl vinyl ether, etc.), vinyl esters (vinyl acetate, vinyl propionate, vinyl cinnamate, etc.), acrylamides (N-tert-butylacrylamide, N-cyclohexylacrylamide, etc.), and methacrylamides, and acrylonitrile derivatives.

The fluorine-containing resin for use in the low-refractive-index layer 50 is not particularly limited and may be suitably selected in accordance with the intended use. For imparting scratch resistance to the low-refractive-index layer 50, a Si oxide ultrafine particle having an average particle diameter of 0.1 μm or smaller is preferred, and a Si oxide ultrafine particles having an average particle diameter of 0.001 μm to 0.05 μm is more preferred. From the viewpoint of improving the light extraction efficiency, the lower the refractive index of the fluorine-containing resin, the more preferred, but the refractive index of the fluorine-containing resin is made low, the robustness degrades. Then, by optimizing the refractive index of the fluorine-containing resin and the addition amount of the Si oxide ultrafine particle, it is possible to appropriately balance the scratch resistance and the low-refractive index. As the Si oxide ultrafine particle, a commercially available silica sol which has been dispersed in an organic solvent may be directly used, or commercially available various silica powders may be used in the form where the silica powder is dispersed in an organic solvent. With use of a hollow silica particle containing air bubbles in Si fine particles, a further lower refractive index can be realized.

In a preferred embodiment of the optical member, the optical member is a film having a transparent substrate 20 provided with a barrier layer, and a light diffusion layer 30 formed on the transparent substrate 20 provided with a barrier layer, wherein in a matrix material 31 of the light diffusion layer 30, a light scattering particle 41 having a refractive index different from that of the matrix material 31 is dispersed; and the refractive index of the matrix material 31 is 1.6 or lower. With this configuration, the total reflection amount in the organic EL light emitting layer is reduced to one-half or less. In this embodiment, at least one type inorganic fine particle selected from ZrO₂, TiO₂, SnO₂, and ZnO is preferably contained in the matrix material 31 of the light diffusion layer 30. With this, the light diffusion layer 30 will be a high refractive layer having light scattering property.

In another preferred embodiment of the optical member, the optical member is a film including a transparent substrate 20 provided with a barrier layer, and a light diffusion layer 30 formed on the transparent substrate 20 provided with a barrier layer, wherein in the matrix material 31 of the light diffusion layer 30, at least one type fine particle which has an average particle diameter of 50 nm to 300 nm and which is selected from ZrO₂, TiO₂, SnO₂ and ZnO is dispersed. With this, the light diffusion layer 30 will be a high refractive layer having light scattering property.

### <Color Filter>

The color filter can be obtained by curing a curable composition containing a colorant and a light scattering particle. For example, the curable composition is applied, via a low-refractive-index layer, onto a transparent substrate or a barrier layer, and curing the curable composition with ultraviolet ray, using a mask pattern, thereby forming a pattern in each of RGB colors. Alternatively, patterns can be formed using an inkjet method for individual pixels.

### <<Curable Composition>>

The curable composition contains at least an alkali soluble resin, a light scattering particle, a colorant, a photosensitive polymerizable component and a photopolymerization initiator, and in general, contains a solvent (hereinbelow, otherwise referred to as an organic solvent). By incorporating the photosensitive polymerizable component and the photopolymerization initiator into the curable composition, the curable composition can be formed as a negative film. Further, the curable composition can be further composed of a crosslinking agent for improving the hardness of film, and other components. The photosensitive polymerizable component in the curable composition is polymerized, and thereby a binder resin is formed.

### <<<Alkali Soluble Resin>>>

The alkali soluble resin is not particularly limited and may be suitably selected in accordance with the intended use. It is, however, preferably an alkali soluble resin which is a linear organic high molecular weight polymer, which is soluble in organic solvent, and which can be developed by a weak alkali aqueous solution.

The linear organic high molecular weight polymer is not particularly limited and may be suitably selected in accordance with the intended use. For example, polymers having a carboxylic acid in the side chain thereof and acidic cellulose derivatives having a carboxylic acid in the side chain thereof, such as the methacrylic acid copolymers, acrylic acid copolymers, itaconic acid copolymers, crotonic acid copolymers, maleic acid copolymers, and partially esterified maleic acid copolymers as described in Japanese Patent Application Laid-Open (JP-A) No. 59-44615, Japanese Patent Application Publication (JP-B) Nos. 54-34327, 58-12577, 54-25957, Japanese Patent Application Laid-Open (JP-A) Nos. 59-53836, and 59-71048 are exemplified. Besides the above, compounds in which acid anhydride is added to a hydroxyl group-containing polymer are also useful.

Among these, preferred are benzyl (meth)acrylate/(meth)acrylic acid copolymers, and multi-component copolymers composed of benzyl(meth)acrylate/(meth)acrylic acid/other monomer. Besides, as a water-soluble polymer, 2-hydroxyethyl methacrylate, polyvinyl pyrrolidone, polyethylene oxides, and polyvinyl alcohols are also useful. In terms of increasing the strength of a cured film, alcohol-soluble nylon, and polyethers between 2,2-bis-(4-hydroxyphenyl)-propane and epichlorohydrin are also useful. These polymers may be used in the form of a mixture in an arbitrary amount.

In addition, copolymers described in Japanese Patent Application Laid-Open (JP-A) No. 7-140654 are also exemplified, such as 2-hydroxypropyl(meth)acrylate/polystyrene macro-monomer/benzyl methacrylate/methacrylic acid copolymers, 2-hydroxy-3-phenoxypropyl acrylate/polymethyl methacrylate macro-monomer/benzyl methacrylate/methacrylic acid copolymers, 2-hydroxyethyl methacrylate/polystyrene macro-monomer/methyl methacrylate/methacrylic acid copolymers, 2-hydroxyethyl methacrylate/polystyrene macro-monomer/benzyl methacrylate/methacrylic acid copolymers.

As the alkali soluble resin, resins having a carboxyl group in the side chain thereof are preferable. From the viewpoint of excellently maintaining the developing property and coatability after exposure to light, those having an acid value of 30 to 200 are preferable.

As described above, in general, most alkali soluble resins are acrylic copolymers in which an unsaturated carboxylic acid is used with the copolymerizable monomer thereof. Among these, acrylic copolymers having a polyalkylene oxide chain in the side chain thereof are preferred in terms of improving liquid properties at the time of preparing a curable composition in the form of a coating liquid, causing less trouble with liquid residues in a coating tube, and easily obtaining a thin coated film with a uniform thickness. In particular, with use of an acrylic copolymer, an excellent coated film can be obtained with a high yield rate in slit coating method which is suitable for coating onto a substrate having a wide width and a large area.

The total amount of the alkali soluble resin used in the curable composition is not particularly limited and may be suitably selected in accordance with the intended use. It is, however, preferably 5% by mass to 80% by mass, more preferably 20% by mass to 60% by mass with respect to the total solid components. When the total amount of the alkali soluble resin is 5% by mass or more, a sufficient film strength can be obtained. When it is 80% by mass or less, it is easily control the solubility because the amount of the acid components is not excessively large, and a sufficient image density can be obtained because the amount of the pigment relatively increases.

Further, in order to improve crosslinking efficiency of the curable composition, the alkali soluble resin may have a polymerizable group in the side chain thereof, and polymers containing an allyl group, (meth)acrylic group, allyloxyalkyl group or the like in the side chain thereof are also useful. The following describes examples of the polymers containing a polymerizable group. It is sufficient that the polymers may contain an alkali soluble group, such as COOH group, OH group, an ammonium group or the like, and an unsaturated bond between carbons.

The alkali soluble resin is not particularly limited and may be suitably selected in accordance with the intended use. For example, there may be exemplified compounds obtained by reacting a copolymer of 2-hydroxyethyl acrylate having an OH group, a methacrylic acid containing a COOH group, and a monomer copolymerizable therewith (e.g., an acrylic or vinyl compound), with a compound having an epoxy ring reactive to the OH group and an unsaturated bond group between carbons (e.g., a compound such as glycidyl acrylate). In the reaction of the OH group, besides the epoxy ring, a compound containing an acid anhydride, isocyanate group and/or acryloyl group can be used. Also, it is possible to use a reaction product obtained by a reaction between a compound which is obtained by reacting the compound having an epoxy ring described in JP-A Nos. 6-102669 and 6-1938 with an unsaturated carboxylic acid such as an acrylic acid, and a saturated or unsaturated polybasic acid anhydride. Specific examples of the compound containing an alkali soluble group, such as COOH group, and an unsaturated group between carbons, include DIANAL NR series (produced by Mitsubishi Rayon Co., Ltd.); PHOTOMER 6173 (a COOH group-containing polyurethane acrylic oligomer, produced by Diamond Shamrock Co. Ltd.); BISCOAT R-264, and KS RESIST 106 (both produced by Osaka Yuki Kagaku K.K.); CYCLOMER P series, and PLACCEL CF200 series (both produced by Daicel Chemical Industries, Ltd.); and EBECRYL 3800 (produced by Daicel UCB Co., Ltd.).

### <<<Light Scattering Particle>>>

The type of the light scattering particle is not particularly limited and may be suitably selected in accordance with the intended use. They may be an organic fine particle or may be an inorganic fine particle.

The organic fine particle is not particularly limited and may be suitably selected in accordance with the intended use. Examples thereof include polymethyl methacrylate beads, acryl-styrene copolymer beads, melamine beads, polycarbonate beads, styrene beads, crosslinked polystyrene beads, polyvinyl chloride beads, and benzoguanamine-melamine formaldehyde beads.

The inorganic fine particle is not particularly limited and may be suitably selected in accordance with the intended use. For example, SiO₂, ZrO₂, TiO₂, Al₂O₃, In₂O₃, ZnO, SnO₂, and Sb₂O₃ are exemplified.

The light scattering particle is preferably at least one type of fine particle having an average particle diameter of 50 nm to 300 nm and selected from ZrO₂, TiO₂, SnO₂, and ZnO.

### <<<Colorant>>>

Details of the colorant are as described above.

The total amount of the colorant used in the curable composition is not particularly limited and may be suitably selected in accordance with the intended use. For example, it is preferably 20% by mass to 60% by mass, more preferably 30% by mass to 55% by mass, still more preferably 35% by mass to 50% by mass, to the total mass of the curable composition. Note that the mass ratio of materials constituting the colorant can be selected according to the intended color.

### <<<Photosensitive Polymerizable Component>>>

The photosensitive polymerizable component is not particularly limited and may be suitably selected in accordance with the intended use. It is, however, preferably a compound having at least one addition-polymerizable ethylenically unsaturated group and having a boiling point of 100° C. or higher under normal pressure. Among such compounds, more preferred are tetrafunctional or higher functional acrylate compounds.

“The compound having at least one addition-polymerizable ethylenically unsaturated group and having a boiling point of 100° C. or higher under normal pressure” is not particularly limited and may be suitably selected in accordance with the intended use. Examples thereof include monofunctional acrylates and methacrylates such as polyethylene glycol mono(meth)acrylate, polypropylene glycol mono(meth)acrylate, and phenoxyethyl(meth)acrylate; compounds obtained by adding an ethylene oxide or a propylene oxide to a polyfunctional alcohol, and then subjecting to (meth)acrylation (e.g. polyethylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol hexa(meth)acrylate, hexane diol (meth)acrylate, trimethylolpropane tri(acryloyloxypropyl)ether, tri(acryloyloxyethyl)isocyanurate, glycerin, and trimethylolethane); poly(meth)acrylated products of pentaerythritol or dipentaerythritol; urethane acrylates as described in Japanese Patent. Application Publication (JP-B) Nos. 48-41708, and 50-6034, and Japanese Patent Application Laid-Open (JP-A) No. 51-37193; polyester acrylates as described in Japanese Patent Application Laid-Open (JP-A) No. 48-64183, Japanese Patent Application Publication (JP-B) Nos. 49-43191, and 52-30490; and polyfunctional acrylates and polyfunctional methacrylates as reaction products between an epoxy resin and a (meth)acrylic acid (e.g., epoxy acrylates). Further, those disclosed as photocurable monomer and oligomers in Nihon Secchaku Kyokai-shi (Japan Adhesive Association), Vol. 20, No. 7, pp. 300-308 can also be used.

As the compounds obtained by adding an ethylene oxide or a propylene oxide to a polyfunctional alcohol, and then subjecting to (meth)acrylation, it is possible to use, as the photosensitive polymerizable component, the specific examples of the compound, and the compounds represented by one of the General Formulas (1) and (2) described in Japanese Patent Application Laid-Open (JP-A) No. 10-62986.

Among these, preferred are dipentaerythritol penta(meth)acrylate, dipentaerythritol hexa(meth)acrylate, and compounds having a structure where these acryloyl groups are attached via an ethylene glycol residue or a propylene glycol residue.

In addition, oligomer type compounds are also favorably used. Acrylic oligomers with monomer repeating units of 3 to 20 (preferably 3 to 10) are preferred.

When an acrylic oligomer is used as the photosensitive polymerizable component, the light exposure sensitivity is increased and the polymerization strength is increased. Therefore, it is difficult to cause peeling-off of a pattern when developing is performed with a developing liquid containing the acrylic oligomer, and the applicable time span for developing is widened. That is, it is possible to widen the developing latitude.

The above photosensitive polymerizable components may be used alone or in combination.

### <<<Photopolymerization Initiator>>>

The photopolymerization initiator is not particularly limited and may be suitably selected in accordance with the intended use. Examples of the photopolymerization initiator include active halogen compounds, such as halomethyl oxadiazole and halomethyl-s-triazine; 3-aryl-substituted coumarine compounds, and at least one lophine dimer. Among these, halomethyl-s-triazine compounds are preferred. Hereinafter, these compounds will be described in detail.

The halomethyl oxadiazole is not particularly limited and may be suitably selected in accordance with the intended use. Examples thereof include 2-halomethyl-5-vinyl-1,3,4-oxadiazole compounds. Specific examples of the 2-halomethyl-5-vinyl-1,3,4-oxadiazole compounds include 2-trichloromethyl-5-styryl-1,3,4-oxadiazole, 2-trichloromethyl-5-(p-cyanostyryl)-1,3,4-oxadiazole, and 2-trichloromethyl-5-(p-methoxystyryl)-1,3,4-oxadiazole.

The halomethyl-s-triazine compound is not particularly limited and may be suitably selected in accordance with the intended use. For example, there may be exemplified vinyl-halomethyl-s-triazine compound described in Japanese Patent Application Publication (JP-B) No. 59-1281, and 2-(naphtho-1-yl)-4,6-bis-halomethyl-s-triazine compound, 4-(p-aminophenyl)-2,6-di-halomethyl-s-triazine compound described in Japanese Patent Application Laid-Open (JP-A) No. 53-133428.

The vinyl-halomethyl-s-triazine compound is not particularly limited and may be suitably selected in accordance with the intended use. Examples thereof include 2,4-bis(trichloromethyl)-6-p-methoxystyryl-s-triazine, 2,4-bis(trichloromethyl)-6-(1-p-dimethylaminophenyl-1,3-buta dienyl)-s-triazine, and 2-trichloromethyl-4-amino-6-p-methoxystyryl-s-triazine.

The 2-(naphtho-1-yl)-4,6-bis-halomethyl-s-triazine compound is not particularly limited and may be suitably selected in accordance with the intended use. Examples thereof include
2-(naphtho-1-yl)-4,6-bis-trichloromethyl-s-triazine,
2-(4-methoxy-naphtho-1-yl)-4,6-bis-trichloromethyl-s-triazine,
2-(4-ethoxy-naphtho-1-yl)-4,6-bis-trichloromethyl-s-triazine,
2-(4-butoxy-naphtho-1-yl)-4,6-bis-trichloromethyl-s-triazine,
2-[4-(2-methoxyethyl)-naphtho-1-yl]-4,6-bis-trichloromethyl-s-triazine,
2-[4-(2-ethoxyethyl)-naphtho-1-yl]-4,6-bis-trichloromethyl-s-triazine,
2-[4-(2-butoxyethyl)-naphtho-1-yl]-4,6-bis-trichloromethyl-s-triazine,
2-(2-methoxy-naphtho-1-yl)-4,6-bis-trichloromethyl-s-triazine,
2-(6-methoxy-5-methyl-naphtho-2-yl)-4,6-bis-trichloromethyl-s-triazine,
2-(6-methoxy-naphtho-2-yl)-4,6-bis-trichloromethyl-s-triazine,
2-(5-methoxy-naphtho-1-yl)-4,6-bis-trichloromethyl-s-triazine,
2-(4,7-dimethoxy-naphtho-1-yl)-4,6-bis-trichloromethyl-s-triazine,
2-(6-ethoxy-naphtho-2-yl)-4,6-bis-trichloromethyl-s-triazine, and
2-(4,5-dimethoxy-naphtho-1-yl) 4,6-bis-trichloromethyl-s-triazine.

The 4-(p-aminophenyl)-2,6-di-halomethyl-s-triazine compound is not particularly limited and may be suitably selected in accordance with the intended use. Examples thereof include 4-[p-N,N-di(ethoxycarbonylmethyl)aminophenyl]-2,6-di(trichloromethyl)-s-triazine,
4-[o-methyl-p-N,N-di(ethoxycarbonylmethyl)aminophenyl]-2,6-di(trichloromethyl)-s-triazine,
4-[p-N,N-di(chloroethyl)aminophenyl]-2,6-di(trichloromethyl)-s-triazine,
4-[o-methyl-p-N,N-di(chloroethyl)aminophenyl]-2,6-di(trichloromethyl)-s-triazine,
4-(p-N-chloroethylaminophenyl)-2,6-di(trichloromethyl)-s-triazine,
4-(p-N-ethoxycarbonylmethylaminophenyl)-2,6-di(trichloromethyl)-s-triazine,
4-[p-N,N-di(phenyl)aminophenyl]-2,6-di(trichloromethyl)-s-triazine,
4-(p-N-chloroethylcarbonylaminophenyl)-2,6-di(trichloromethyl)-s-triazine,
4-[p-N-(p-methoxyphenyl)carbonylaminophenyl]2,6-di(trichloromethyl)-s-triazine,
4-[m-N,N-di(ethoxycarbonylmethyl)aminophenyl]-2,6-di(trichloromethyl)-s-triazine,
4-[m-bromo-p-N,N-di(ethoxycarbonylmethypaminophenyl]-2,6-di(trichloromethyl)-s-triazine,
4-[m-chloro-p-N,N-di(ethoxycarbonylmethyl)aminophenyl]-2,6-di(trichloromethyl)-s-triazine,
4-[m-fluoro-p-N,N-di(ethoxycarbonylmethyl)aminophenyl]-2,6-di(trichloromethyl)-s-triazine,
4-[o-bromo-p-N,N-di(ethoxycarbonylmethyl)aminophenyl]-2,6-di(trichloromethyl)-s-triazine,
4-[o-chloro-p-N,N-di(ethoxycarbonylmethyl)aminophenyl]-2,6-di(trichloromethyl)-s-triazine,
4-[o-fluoro-p-N,N-di(ethoxycarbonylmethyl)aminophenyl]-2,6-di(trichloromethyl) s-triazine,
4-[o-bromo-p-N,N-di(chloroethyl)aminophenyl]-2,6-di(trichloromethyl)-s-triazine,
4-[o-chloro-p-N,N-di(chloroethyl)aminophenyl]-2,6-di(trichloromethyl)-s-triazine,
4-[o-fluoro-p-N,N-di(chloroethylaminophenyl]-2,6-di(trichloromethyl)-s-triazine,
4-[m-bromo-p-N,N-di(chloroethylaminophenyl]-2,6-di(trichloromethyl)-s-triazine,
4-[m-chloro-p-N,N-di(chloroethylaminophenyl]-2,6-di(trichloromethyl)-s-triazine,
4-[m-fluoro-p-N,N-di(chloroethylaminophenyl]-2,6-di(trichloromethyl)-s-triazine,
4-(m-bromo-p-N-ethoxycarbonylmethylaminophenyl)-2,6-di(trichloromethyl)-s-triazine,
4-(m-chloro-p-N-ethoxycarbonylmethylaminophenyl)-2,6-di(trichloromethyl)-s-triazine,
4-(m-fluoro-p-N-ethoxycarbonylmethylaminophenyl)-2,6-di(trichloromethyl)-s-triazine,
4-(o-bromo-p-N-ethoxycarbonylmethylaminophenyl)-2,6-di(trichloromethyl)-s-triazine,
4-(o-chloro-p-N-ethoxycarbonylmethylaminophenyl)-2,6-di(trichloromethyl)-s-triazine,
4-(o-fluoro-p-N-ethoxycarbonylmethylaminophenyl)-2,6-di(trichloromethyl)-s-triazine,
4-(m-bromo-p-N-chloroethylaminophenyl)-2,6-di(trichloromethyl)-s-triazine,
4-(m-chloro-p-N-chloroethylaminophenyl)-2,6-di(trichloromethyl)-s-triazine,
4-(m-fluoro-p-N-chloroethylaminophenyl)-2,6-di(trichloromethyl)-s-triazine,
4-(o-bromo-p-N-chloroethylaminophenyl)-2,6-di(trichloromethyl)-s-triazine,
4-(o-chloro-p-N-chloroethylaminophenyl)-2,6-di(trichloromethyl)-s-triazine, and
4-(o-fluoro-p-N-chloroethylaminophenyl)-2,6-di(trichloromethyl)-s-triazine.

A sensitizer may be used in combination with the photopolymerization initiator. The sensitizer is not particularly limited and may be suitably selected in accordance with the intended use. Examples thereof include benzoin, benzoin methyl ether, benzoin, 9-fluorenone, 2-chloro-9-fluorenone, 2-methyl-9-fluorenone, 9-anthrone, 2-bromo-9-anthrone, 2-ethyl-9-anthrone, 9,10-anthraquinone, 2-ethyl-9,10-anthraquinone, 2-t-butyl-9,10-anthraquinone, 2,6-dichloro-9,10-anthraquinone, xanthone, 2-methylxanthone, 2-methoxyxanthone, 2-methoxyxanthone, thioxanthone, benzyl, dibenzalacetone, p-(dimethylamino)phenyl styryl ketone, p-(dimethylamino)phenyl-p-methyl styryl ketone, benzophenone, p-(dimethylamino)benzophenone (or Michler's ketone), p-(diethylamino)benzophenone, benzoanthrone, and benzothiazole compounds described in JP-B No. 51-48516.

As the above-mentioned 3-aryl-substituted coumarine compound exemplified as the photopolymerization initiator, {(s-triazine-2-yl)amino}-3-aryl coumarine compounds are preferred.

The above-mentioned lophine dimer exemplified as the photopolymerization initiator means a 2,4,5-triphenylimidazole dimer composed of two lophine group residues. Specific examples thereof include
2-(o-chlorophenyl)-4,5-diphenyl imidazole dimer,
2-(o-fluorophenyl)-4,5-diphenylimidazole dimer,
2-(o-methoxyphenyl)-4,5-diphenylimidazole dimer,
2-(p-methoxyphenyl)-4,5-diphenylimidazole dimer, 2-(p-dimethoxyphenyl)-4,5-diphenylimidazole dimer,
2-(2,4-dimethoxyphenyl)-4,5-diphenylimidazole dimer, and
2-(p-methylmercaptophenyl)-4,5-diphenylimidazole dimer.

As the photopolymerization initiator, besides the above photopolymerization initiators, other known compounds can also be used. For example, there may be exemplified vicinal polyketol aldonyl compounds described in U.S. Pat. No. 2,367,660; α-carbonyl compounds described in U.S. Pat. Nos. 2,367,661 and 2,367,670; acyloin ethers described in U.S. Pat. No. 2,448,828, α-hydrocarbon-substituted aromatic acyloin compounds described in U.S. Pat. No. 2,722,512; polynuclear quinone compounds described in U.S. Pat. Nos. 3,046,127 and 2,951,758; a combination of triallyl imidazole dimer/p-aminophenyl ketone described in U.S. Pat. No. 3,549,367, and benzothiazole compound/trihalomethylol-s-triazine compound described in JP-B No. 51-48516. Further, ADEKA OPTOMER SP-150, 151, 170, 171, N-1717, and N1414 produced by Asahi Denka Kogyo K.K. can also be used as the photopolymerization initiator.

The amount of the photopolymerization initiator contained in the curable composition is not particularly limited and may be suitably selected in accordance with the intended use. It is preferably 0.1% by mass to 10.0% by mass, more preferably 0.5% by mass to 5.0% by mass relative to the total solid content of the curable composition. When the amount of the photopolymerization initiator is 0.1% by mass or more, polymerization easily proceeds in an assured manner. When it is 10.0% by mass or less, a sufficient film strength can be obtained.

### <<<Solvent>>>

In preparation of the curable composition, the curable composition generally contains a solvent (otherwise, referred to as “organic solvent” in the present invention). Basically, the solvent is not particularly limited as long as the solubility of each component and the coatability of the curable composition are satisfied. The solvent is, however, preferably selected in consideration of especially, the solubility, coatability and safety of the colorant and the resin components.

The solvent is not particularly limited and may be suitably selected in accordance with the intended use. Preferred examples of the solvent include esters such as ethyl acetate, n-butyl-acetate, isobutyl acetate, amyl formate, isoamyl acetate, isobutyl acetate, butyl propionate, isopropyl butyrate, ethyl butyrate, butyl butyrate, alkyl esters, methyl lactate, ethyl lactate, methyl oxyacetate, ethyl oxyacetate, butyl oxyacetate, methyl oxyacetate, ethyl methoxyacetate, butyl methoxyacetate, methyl ethoxyacetate, and ethyl ethoxyacetate; 3-oxypropionic acid alkyl esters such as methyl 3-oxypropionate (e.g., methyl 3-methoxypropionate, methyl 3-ethoxypropionate, etc.) and ethyl 3-oxypropionate (e.g. ethyl 3-methoxy propionate, ethyl 3-ethoxypropionate, etc.); 2-oxypropionic acid alkyl esters such as methyl 2-oxypropionate (e.g., methyl 2-methoxypropionate, methyl 2-ethoxypropionate, methyl 2-oxy-2-methyl propionate, methyl 2-methoxy-2-methyl propionate), ethyl 2-oxypropionate (e.g., ethyl 2-methoxypropionate, ethyl 2-ethoxypropionate, ethyl 2-oxy-2-methylpropionate, ethyl 2-ethoxy-2-methylpropionate, etc.), propyl 2-methoxypropionate, and propyl 2-oxypropionate, etc.; methyl pyruvate, ethyl pyruvate, propyl pyruvate, acetomethyl acetate, acetoethyl acetate, 2-methyl oxobutanoic acid, and 2-ethyl oxobutanoic acid; ethers such as diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol methyl ether, propylene glycol methyl ether acetate, propylene glycol ethyl ether acetate, and propylene glycol propyl ether acetate; ketones such as methylethylketone, cyclohexanone, 2-heptanone, and 3-heptanone; aromatic hydrocarbons such as toluene, and xylene; ethyl carbitol acetate, and butyl carbitol acetate.

Among these, preferred are 3-ethoxy methyl propionate, 3-ethoxy ethyl propionate, ethyl cellosolve acetate, ethyl lactate, diethylene glycol dimethyl ether, butyl acetate, 3-methoxy methyl propionate, 2-heptane, cyclohexanone, ethyl carbitol acetate, butyl carbitol acetate, propylene glycol methyl ether, and propylene glycol methyl ether acetate. These solvents may be used alone or in combination.

### <<<Various Additives>>>

To the curable composition, various additives, for example, a filler, high-molecular weight compounds other than the above-mentioned, a surfactant, adhesion accelerator, antioxidant, ultraviolet absorbent, aggregation inhibitor, etc. may be added.

Specific examples of these additives include fillers such as glass, and alumina; itaconic acid copolymers, crotonic acid copolymers, maleic acid copolymers, partially esterified maleic acid copolymers, acidic cellulose derivatives, compounds in which acid anhydride is added to a hydroxyl group-containing polymer, alcohol soluble nylon, and alkali soluble resins such as phenoxy resins formed of bisphenol A and epichlorohydrin; nonionic, cationic or anionic surfactants, specifically, cationic surfactants such as phthalocyanine derivatives (EFKA-745, produced by Morishita Sangyo K.K.); organosiloxane polymer KP341 (produced by Shin-Etsu Chemical Co., Ltd.), (meth)acrylic acid (co)polymer POLYFLOW No. 75, No. 90, No. 95 (produced by Kyoeisha Chemical Co., Ltd.), and W001 (produced by Yusho Co., Ltd.); nonionic surfactants such as polyoxyethylene lauryl ether, polyoxyethylene stearyl ether, polyoxyethylene oleyl ether, polyoxyethylene octylphenyl ether, polyoxyethylene nonylphenyl ether, polyethylene glycol dilaurate, polyethylene glycol distearate, sorbitan fatty acid ester (PLURONIC L10, L31, L61, L62, 10R5, 17R2, and 25R2, TETRONIC 304, 701, 704, 901, 904, and 150R1 produced by BASF); fluorochemical surfactants such as EFTOP EF301, EF303, and EF352 (produced by Shin-Akita Chemical Co., Ltd.), and MEGAFACE F-141, F-142, F-143, and F-144 (produced by Daimppon Ink Chemical Industries Co., Ltd.); anionic surfactants such as W004, W005, and W017 (produced by Yusho Co., Ltd.); high molecular weight dispersants such as EFKA-46, EFKA-47, EFKA-47EA, EFKA POLYMER 100, EFKA POLYMER 400, EFKA POLYMER 401, and EFKA POLYMER 450 (produced by Morishita Sangyo K.K), and DISPERSE AID 6, DISPERSE AID 8, DISPERSE AID 15, and DISPERSE AID 9100 (produced by San Nopco Limited); various SOLSPERSE dispersants of SOLSPERSE 3000, 5000, 9000, 12000, 13240, 13940, 17000, 24000, 26000, and 28000 (produced by Zeneca Inc.); ADEKA PLURONIC L31, F38, L42, L44, L61, L64, F68, L72, P95, F77, P84, F87, P94, L101, P103, F108, L121, and P-123 (produced by Asahi Denka Kogyo K.K.), and ISONET S-20(produced by Sanyo Chemical Industries, Ltd.); adhesion accelerators such as vinyl trimethoxysilane, vinyl triethoxysilane, vinyl tris(2-methoxyethoxy)silane, N-(2-aminoethyl)-3-aminomethyl-propyl dimethoxy silane, N-(2-aminoethyl)-3-aminopropyl trimethoxy silane, 3-aminopropyl triethoxy silane, 3-glycidoxypropyl trimethoxy silane, 3-glycidoxypropyl methyl dimethoxy silane, 2-(3,4-epoxycyclohexyl)ethyl trimethoxy silane, 3-chloropropyl methyl dimethoxy silane, 3-chloropropyl trimethoxy silane, 3-methacryloxy propyl trimethoxy silane, and 3-mercaptopropyl trimethoxy silane; antioxidants such as 2,2-thiobis(4-methyl-6-t-butylphenol), and 2,6-di-t-butylphenol; ultraviolet absorbents such as 2-(3-t-butyl-5-methyl-2-hydroxyphenyl)-5-chlorobenzotriazole, and alkoxybenzophenone; and aggregation inhibitors such as sodium polyacrylates.

Further, in order to accelerate the alkali solubility in non-image portions and to further improve the developing property of the curable composition, an organic carboxylic acid, preferably, a low-molecular-weight organic carboxylic acid having a molecular weight of 1,000 or lower can becadded to the curable composition. Specific examples of the organic carboxylic acid include aliphatic monocarboxylic acids such as formic acid, acetic acid, propionic acid, butyric acid, valeric acid, pivalic acid, caproic acid, diethyl acetic acid, enanthic acid, and caprylic acid; aliphatic dicarboxylic acids such as oxalic acid, malonic acid, succinic acid, glutaric acid, adipic acid, pimelic acid, suberic acid, azelaic acid, sebacic acid, brassylic acid, methyl malonic acid, ethyl malonic acid, dimethyl malonic acid, methyl succinic acid, tetramethyl succinic acid, and citraconic acid; aliphatic tricarboxylic acids such as tricarballylic acid, aconitic acid, and camphoronic acid; aromatic monocarboxylic acids such as benzoic acid, toluic acid, cumenic acid, hemellitic acid and mesitylenic acid; aromatic polycarboxylic acids such as phthalic acid, isophthalic acid, terephthalic acid, trimellitic acid, trimesic acid, mellophanic acid, and pyrollitic acid; and other carboxylic acids such as phenyl acetic acid, hydroatropic acid, hydrocinnamic acid, mandelic acid, phenyl succinic acid, atropic acid, cinnamic acid, methyl cinnamic acid, benzyl cinnamic acid, cinnamylidene acetic acid, coumaric acid, and umbellic acid.

Also, it is preferred that besides the above additives, a thermopolymerization inhibitor be further added to the curable composition. The thermopolymerization inhibitor is not particularly limited and may be suitably selected in accordance with the intended use. Examples thereof include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and 2-mercaptobenzoimidazole.

A cured product of the curable composition preferably has a refractive index or 1.6 or higher. With this, the amount of the total reflection in the organic EL light emitting layer is reduced to one-half or less.

Further, it is preferred that at least one type of organic fine particle selected from ZrO₂, TiO₂, SnO₂, and ZnO be contained in the curable composition.

In the curable composition, the refractive index of the light scattering particle is preferably 1.55 or lower. With this, a sufficient amount of light scattering can be obtained.

In the curable composition, the average particle diameter of the light scattering particle is preferably 0.1 μm to 2.0 μm. With this, a sufficient light scattering amount is obtained and the directionality of light scattering is substantially isotropic scattering. By making light-scattering directionality close to isotropic scattering, a larger amount of light can be extracted.

The curable composition can be generally prepared by mixing, with a solvent, a light scattering particle, a colorant, alkali soluble resins, photosensitive polymerizable components and a photopolymerization initiator, and further various additives used as required, and then mixing and dispersing the components using various types of mixers and dispersing machines.

For example, the curable composition of the present invention can be favorably produced in the following manner. Specifically, in a colorant, a surface modifier or a dispersant, an alkali soluble resin, and a solvent are mixed, and then kneaded and dispersed. A machine for use in the kneading and dispersing is a double roll, triple roll, ball mill, disperser, kneader, homogenizer, blender or the like. The components are dispersed under application of a strong shearing force. Next, to the resulting kneaded dispersion, a photosensitive polymerizable component and a photopolymerization initiator, and further a solvent, a dispersant, an alkali soluble resin, a light scattering particle and other components selected as required are added. These components are finely dispersed, through use of beads made of glass, zirconia, or the like, having a particle diameter of 0.1 mm to 10 mm as a dispersion medium, by mainly using a sand grinder, pin mill, slit mill, ultrasonic dispersing machine or the like. Note that this kneading-dispersing treatment may be omitted. In that case, the colorant, dispersant or surface treatment agent, alkali soluble resin and solvent are finely dispersed.

Details of the kneading/dispersing treatment are described in “Paint Flow and Pigment Dispersion” written by T. C. Patton (published by John Wiley and Sons, 1964) and the like.

### <<Production Method of Color Filter>>

The color filter for use in the present invention can be prepared by applying the curable composition onto a transparent substrate or a barrier layer, and ultraviolet-curing the coating, through a mask pattern, thereby forming a pattern of each of RGB colors. The patterns may also be formed using an inkjet method for individual pixels. The following describes in detail a method of preparing a color filter by applying curable composition onto a substrate, onto the upper electrode of an organic EL, or onto the barrier layer of an organic EL.

The color filter for use in the present invention is prepared using at least three kinds of curable compositions differing in the colorant composition. Out of these three kinds of curable compositions, any one curable composition is applied onto a substrate, exposed through a mask and developed to form pixels in the first color. After the formation of pixels in the first color, other one curable composition selected from those colored curable compositions, which are different in the color and hue from the pixels in the first color, is applied onto the substrate, exposed through a mask and developed to form pixels in the second color. Furthermore, after the formation of pixels in the second color, other one curable composition selected from those colored curable compositions, which are different in the color and hue from the first and second colors, is applied onto the substrate, exposed through a mask and developed to form pixels in the third color, whereby the color filter is obtained. The color filter may also be constructed to have four or more colors by further forming pixels in addition to the first to third colors (for example, green, red and blue).

That is, using at least three kinds of the curable compositions in a desired order of colors, a step of applying a curable composition onto a substrate by a coating method such as spin coating, cast coating or roll coating, drying the coating to from a radiation-sensitive layer, exposing the layer through a predetermined mask pattern, and subsequently developing the layer with a developer to form pixels in a desired pattern is repeated at least three times according to the number of colored compositions, whereby the color filter can be obtained. At this time, a step of curing the formed pixels by means of heating and/or exposure may be provided, if desired. This exposure may be effected by irradiating radiation. The radiation used here is preferably an ultraviolet ray such as g-line, h-line or i-line.

The substrate constituting the color filter is not particularly limited and may be suitably selected in accordance with the intended use. Examples thereof include soda glass used for liquid crystal display devices and the like, Pyrex (registered) glass, quartz glass and those obtained by attaching a transparent electrically conductive film to such a glass. Also, the color filter may be constructed after previously forming a low-refractive-index layer on such a substrate. Furthermore, the color filter may be constructed directly on the upper electrode or barrier layer constituting an organic EL device. In some cases, black stripes for isolating individual pixels are formed on the substrate.

The developer is not particularly limited and may be suitably selected in accordance with the intended use. Any developer may be used as long as it dissolves the uncured part of the curable composition for use in the present invention and does not dissolve the cured part. Specifically, a combination of various organic solvents or an alkaline aqueous solution may be used. The organic solvent is not particularly limited and may be suitably selected in accordance with the intended use. Examples of the organic solvent include the above-described solvents which are used in preparing the curable composition.

The alkaline aqueous solution is not particularly limited and may be suitably selected in accordance with the intended use. The alkaline aqueous solution is suitably an alkaline aqueous solution where an alkaline compound, such as sodium hydroxide, potassium hydroxide, sodium carbonate, sodium silicate, sodium metasilicate, aqueous ammonia, ethylamine, diethylamine, dimethylethanolamine, tetramethylammonium hydroxide, tetraethylammonium hydroxide, choline, pyrrole or piperidine, is dissolved to a concentration of 0.001% by mass to 10% by mass, preferably from 0.01% by mass to 1% by mass. In the case of using a developer containing such an alkaline aqueous solution, the coating is generally washed with water after development.

### (Organic Electroluminescence Display Device)

The organic electroluminescence display device of the present invention is a display device where an optical member is provided, and a light emitting layer or a plurality of organic compound thin films including a light emitting layer are formed between a pair of electrodes, that is, an anode and a cathode, and may have a hole injection layer, a hole transporting layer, an electron injection layer, an electron transporting layer, a protective layer and the like, in addition to the light emitting layer, and these layers each may have other functions. For the formation of each layer, various materials can be used.

### <Anode>

The anode supplies holes to the hole injection layer, hole transporting layer, light emitting layer or the like. The material of the anode is not particularly limited and may be suitably selected in accordance with the intended use. Examples thereof include a metal, an alloy, a metal oxide, an electrically conductive compound, a mixture thereof or the like. The material preferably has a work function of 4 eV or more. Specific examples thereof include an electrically conductive metal oxide such as tin oxide, zinc oxide, indium oxide and indium tin oxide (ITO), a metal such as gold, silver, chromium and nickel, a mixture or laminate of such a metal and such an electrically conductive metal oxide, an inorganic electrically conductive substance such as copper iodide and copper sulfide, an organic electrically conductive material such as polyaniline, polythiophene and polypyrrole, and a laminate of such a material with ITO. An electrically conductive metal oxide is preferred, and ITO is more preferred in view of productivity, high electrical conductivity, transparency and the like. The thickness of the anode is not particularly limited and may be suitably selected in accordance with the intended use, and may be suitably selected in accordance with the intended use. The thickness is, however, preferably from 10 nm to 5 μm, more preferably from 50 nm to 1 μm, still more preferably from 100 nm to 500 nm.

The anode is not particularly limited and may be suitably selected in accordance with the intended use. For example, there may be exemplified a layer formed on soda lime glass, non-alkali glass, a transparent resin substrate or the like. In the case of using glass, the material thereof is preferably non-alkali glass so as to reduce ion eluted out from the glass. In the case of using soda lime glass, this is preferably used after applying thereto a barrier coat such as silica. The thickness of the substrate is not particularly limited as long as it is sufficiently thick to maintain the mechanical strength. In the case of using glass, the thickness of the glass is not particularly limited as long as it is 0.2 mm or more, and may be suitably selected in accordance with the intended use. A glass having a thickness of 0.7 mm or more is preferred.

A barrier film may also be used as the transparent resin substrate. The barrier film is a film produced by providing a gas-impermeable barrier layer on a plastic support. Examples of the barrier film include those where silicon oxide or aluminum oxide is vapor-deposited (see Japanese Patent Application Publication (JP-B) No. 53-12953 and Japanese Patent Application Laid-Open (JP-A) No. 58-217344), an organic-inorganic hybrid coating layer is provided (see JP-A Nos. 2000-323273 and 2004-25732), an inorganic layered compound is provided (see JP-A No. 2001-205743), an inorganic material is stacked (see, JP-A Nos. 2003-206361 and 2006-263989), an organic layer and an inorganic layer are alternately stacked (see JP-A No. 2007-30387, U.S. Pat. No. 6,413,645, and Affinito et al., Thin Solid Films, pp. 290-291 (1996)), or an organic layer and an inorganic layer are continuously stacked (see U.S. Patent No. 2004-46497).

In the production of the anode, various methods are employed according to the material. For example, in the case of ITO, examples of the film formation method include an electron beam method, a sputtering method, a resistance heating vapor deposition method, a chemical reaction method (e.g., sol-gel method), and a method of coating an indium tin oxide dispersion. When the anode is subjected to cleaning or other treatments, this enables decreasing the driving voltage or improving the light emission efficiency of the display device. For example, in the case of ITO, a UV-ozone treatment or the like is effective.

### <Cathode>

The cathode supplies electrons to the electron injection layer, electron transporting layer, light emitting layer or the like, and the material therefor is selected by taking into consideration the adhesion to a layer adjacent to the negative electrode, such as electron injection layer, electron transporting layer or light-emitting layer, the ionization potential, the stability and the like. The material of the cathode is not particularly limited and may be suitably selected in accordance with the intended use. For example, a metal, an alloy, a metal oxide, an electrically conductive compound or a mixture thereof can be used. Specific examples of the material include an alkali metal (e.g., Li, Na, K) or a fluoride thereof, an alkaline earth metal (e.g., Mg, Ca) or a fluoride thereof, gold, silver, lead, aluminum, an alloy or mixed metal of sodium and potassium, an alloy or mixed metal of lithium and aluminum, an alloy or mixed metal of magnesium and silver, and a rare earth metal such as indium and ytterbium. Among these, preferred is a material having a work function of 4 eV or less, and more preferred are aluminum, an alloy or mixed metal of lithium and aluminum, and an alloy or mixed metal of magnesium and silver. The thickness of the cathode is not particularly limited and may be suitably selected in accordance with the intended use. The thickness is, however, preferably from 10 nm to 5 μm, more preferably from 50 nm to 1 μm, still more preferably from 100 nm to 1 μm. Examples of the production method of the cathode include an electron beam method, a sputtering method, a resistance heating vapor deposition method and a coating method, and a single metal component may be vapor-deposited or two or more components may be simultaneously vapor-deposited. Furthermore, an alloy electrode may also be formed by simultaneously vapor-depositing a plurality of metals, or an alloy previously prepared may be vapor-deposited.

The sheet resistance of the anode and cathode is preferably lower, and is preferably several hundreds of Ω/square or less.

The invasion of a gas can be prevented not only by laminating the above-described barrier film on the cathode but also by forming a protective layer on the display surface.

### <Light Emitting Layer>

The material for the light emitting layer is not particularly limited and may be any material as long as it can form a layer having functions to receive, at the time of electric field application, holes from the anode, hole injecting layer or hole transporting layer, and to receive electrons from the cathode, electron injection layer or electron transporting layer, and offer the field of recombination of holes and electrons to emit light. Examples thereof include various metal complexes as typified by a metal complex or rare earth complex of benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, perylene derivatives, perynone derivatives, oxadiazole derivatives, aldazine derivatives, pyralidine derivatives, cyclopentadiene derivatives, bisstyrylanthracene derivatives, quinacridone derivatives, pyrrolopyridine derivatives, thiadiazolopyridine derivatives, cyclopentadiene derivatives, styrylamine derivatives, aromatic dimethylidine compound or 8-quinolinol derivatives; and a polymer compound such as polythiophene, polyphenylene and polyphenylenevinylene.

The thickness of the light emitting layer is not particularly limited and may be suitably selected in accordance with the intended use. The thickness is, however, preferably from 1 nm to 5 μm, more preferably from 5 nm to 1 μm, still more preferably from 10 nm to 500 nm.

The method of forming the light emitting layer is not particularly limited, and may be suitably selected in accordance with the intended use. Examples of the method include a resistance heating vapor deposition method, an electron beam method, a sputtering method, a molecular lamination method, a coating method (e.g., spin coating, casting, dip coating) and a LB method. Among these, resistance heating vapor deposition method and coating method are preferred.

### <Hole Injection Layer and Hole Transporting Layer>

The material of the hole injection layer and hole transporting layer is not particularly limited as long as it has any one of a function of injecting holes from the anode, a function of transporting holes, and a function of blocking the electrons injected from the cathode, and may be suitably selected in accordance with the intended use. Examples thereof include a carbazole derivative, triazole derivative, oxazole derivative, oxadiazole derivative, imidazole derivative, polyarylalkane derivative, pyrazoline derivative, pyrazolone derivative, phenylenediamine derivative, arylamine derivative, amino-substituted chalcone derivative, styrylanthracene derivative, fluorenone derivative, hydrazone derivative, stilbene derivative, silazane derivative, aromatic tertiary amine compound, styrylamine compound, aromatic dimethylidine compound, porphyrin-based compound, polysilane-based compound, poly(N-vinylcarbazole) derivative, aniline-based copolymer, and an electrically conductive polymer or oligomer such as thiophene oligomer and polythiophene.

The thickness of the hole injection layer and hole transport layer is not particularly limited, and may be suitably selected in accordance with the intended use. The thickness is, however, preferably from 1 nm to 5 μm, more preferably from 5 nm to 1 μm, still more preferably from 10 nm to 500 nm. The hole injection layer and hole transporting layer may take a single-layer structure containing one or two or more of the above-mentioned materials, or a multilayer structure composed of plural layers of a homogeneous composition or a heterogeneous composition.

The method of forming the hole injection layer and hole transporting layer, a vacuum vapor deposition method, a LB method, or a method of dissolving or dispersing the above-described hole injection/transport material in a solvent and coating the obtained solution (e.g., spin coating, casting, dip coating) is used. In the case of a coating method, the resin component is not particularly limited as long as the materials can be dissolved or dispersed together with the resin component in the solvent. Examples of the resin component include polyvinyl chloride, polycarbonate, polystyrene, polymethyl methacrylate, polybutyl methacrylate, polyester, polysulfone, polyphenylene oxide, polybutadiene, poly(N-vinylcarbazole), hydrocarbon resin, ketone resin, phenoxy resin, polyamide, ethyl cellulose, vinyl acetate, ABS resin, polyurethane, melamine resin, unsaturated polyester resin, alkyd resin, epoxy resin and silicon resin.

### <Electron Injection Layer and Electron Transporting Layer>

The material of the electron injection layer and electron transporting layer is not particularly limited as long as it has any one of a function of injecting electrons from the cathode, a function of transporting electrons, and a function of blocking the holes injected from the anode. Specific examples of the material include various metal complexes as typified by a metal complex of triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, heterocyclic tetracarboxylic acid anhydride (e.g., naphthaleneperylene), phthalocyanine derivatives or 8-quinolinol derivatives, and a metal complex in which the ligand is metal phthalocyanine, benzoxazole or benzothiazole.

The thickness of the electron injection layer and electron transport layer is not particularly limited, and may be suitably selected in accordance with the intended use. The thickness is, however, preferably from 1 nm to 5 μm, more preferably from 5 nm to 1 μm, still more preferably from 10 nm to 500 nm. The electron injection layer and the electron transport layer may take a single-layer structure containing one or two or more of the above-mentioned materials, or a multilayer structure composed of plural layers of a homogeneous composition or a heterogeneous composition.

The method of forming the electron injection layer and electron transport layer is not particularly limited and may be suitably selected in accordance with the intended use. Examples of the method include a vacuum vapor deposition method, a LB method, and a method of dissolving or dispersing the above-described electron injection/transport material in a solvent and coating the obtained solution (e.g., spin coating, casting, dip coating). In the case of a coating method, the resin component is not particularly limited as long as the materials can be dissolved or dispersed together with the resin component in the solvent. As the resin component, for example, those described above for the hole injection/transport layer are exemplified.

### <Protective Layer>

The material of the protective layer is not particularly limited as long as it has a function of blocking a material which accelerates degradation of the display device, such as water and oxygen, from entering into the display device. Specific examples thereof include metals such as In, Sn, Pb, Au, Cu, Ag, Al, Ti, and Ni; metal oxides such as MgO, SiO, SiO₂, Al₂O₃, GeO, NiO, CaO, BaO, Fe₂O₃, Y₂O₃, and TiO₂; metal fluorides such as MgF₂, LiF, AlF₃, and CaF₂; polyethylene, polypropylene, polymethyl methacrylate, polyimide, polyurea, polytetrafluoroethylene, polychlorotrifluoroethylene, polydichlorofluoroethylene, a copolymer of chlorotrifluoroethylene and dichlorodifluoroethylene, a copolymer obtained by copolymerizing a monomer mixture containing tetrafluoroethylene and at least one comonomer, a fluorine-containing copolymer having a cyclic structure in the copolymer main chain, a water-absorbing substance having a water absorption rate of 1% or more, and a moisture-resistant substance having a water absorption rate of 0.1% or less.

The method of forming the protective layer is not particularly limited and may be suitably selected in accordance with the intended use. For example, there are exemplified a vacuum deposition method, sputtering method, reactive sputtering method, MBE (Molecular Beam epitaxy) method, cluster ion beam method, ion plating method, plasma polymerization method (high-frequency excited ion plating method), plasma CVD method, laser CVD method, thermal CVD method, gas-source CVD method, and coating method.

### <Attaching Method of Optical Member>

As a method of providing the optical member of the present invention in an organic electroluminescence display device so as to be used, there is a method in which the optical member is directly attached, via an adhesive or tackiness agent, on the light-extraction side electrode or barrier layer of the organic EL. That is, in one embodiment of the organic electroluminescence display device of the present invention, the optical member is directly attached on the upper electrode.

In another embodiment of the organic electroluminescence display device of the present invention, the optical member is attached on the upper electrode through a barrier layer or attached directly on the barrier layer.

In the case where the optical member is a light diffusing film, the preferred embodiment of the organic electroluminescence display device of the present invention includes an embodiment where the optical member (light diffusing film) is attached on the upper electrode or the barrier layer provided on the upper electrode, through an adhesion layer.

### <<Adhesion Layer>>

The refractive index of the adhesion layer composed of an adhesive is not particularly limited and may be suitably selected in accordance with the intended use. It is, however, preferably equal to or greater than that of the organic layer including the light emitting layer. If the refractive index is excessively large, the efficiency decreases due to reflection at the interface. Therefore, the difference in the refractive index from the organic layer is preferably 0.2 or less. In other words, the refractive index of the adhesion layer is preferably 1.5 to 1.9, more preferably from 1.6 to 1.9, particularly preferably from 1.65 to 1.9, in that an amount of total reflection in an organic EL emitting layer is one half or less. As another method for suppressing reflection at the interface, there may be used a method of creating a refractive index gradation in the adhesion layer to allow for bonding of the adhesive and the material at both ends of the adhesive without discontinuity in the refractive index.

The adhesive is preferably an adhesive which flows under heating or pressure, more preferably an adhesive which exhibits flowability under heating at 200° C. or lower or under pressure of 1 kgf/cm² or more. By using such an adhesive, the light diffusing film for use in the present invention can be attached to an adherend, that is, a display or plastic plate, by fluidizing the adhesive. The adhesive can be fluidized, so that an optical film can be easily attached to an adherend by lamination or pressing, particularly pressing, or even to an adherend having a curved surface or a complicated shape. To this end, the softening temperature of the adhesive is preferably 200° C. or lower. Considering usage of the optical film, the use environment is usually at a temperature of lower than 80° C. and therefore, the softening temperature of the adhesion layer is preferably 80° C. or higher, and in view of processability, most preferably from 80° C. to 120° C. The softening point indicates a temperature at which the viscosity becomes 10¹² poises or less (10¹³ Pa·s or less), and the adhesive is usually fluidized within a time of approximately from about 1 second to about 10 seconds at the above-described temperature.

As the adhesive which flows under heating or pressure, for example, thermoplastic resins are exemplified. The thermoplastic resin is not particularly limited and may be suitably selected in accordance with the intended use. Examples thereof include natural rubber (refractive index n=1.52), (di)enes such as polyisoprene (n=1.521), poly-1,2-butadiene (n=1.50), polyisobutene (n=1.505 to 1.51), polybutene (n=1.513), poly-2-heptyl-1,3-butadiene (n=1.50), poly-2-tert-butyl-1,3-butadiene (n=1.506) and poly-1,3-butadiene (n=1.515), polyethers such as polyoxyethylene (n=1.456), polyoxypropylene (n=1.450), polyvinyl ethyl ether (n=1.454), polyvinyl hexyl ether (n=1.459) and polyvinyl butyl ether (n=1.456), polyesters such as polyvinyl acetate (n=1.467) and polyvinyl propionate (n=1.467), polyurethane (n=1.5 to 1.6), ethyl cellulose (n=1.479), polyvinyl chloride (n=1.54 to 1.55), polyacrylonitrile (n=1.52), polymethacrylonitrile (n=1.52), polysulfone (n=1.633), polysulfide (n=1.6), phenoxy resin (n=1.5 to 1.6), and poly(meth)acrylic acid esters such as polyethyl acrylate (n=1.469), polybutyl acrylate (n=1.466), poly-2-ethylhexyl acrylate (n=1.463), poly-tert-butyl acrylate (n=1.464), poly-3-ethoxypropyl acrylate (n=1.465), polyisoxycarbonyl tetramethylene (n=1.465), polymethyl acrylate (n=1.472 to 1.480), polyisopropyl methacrylate (n=1.473), polydodecyl methacrylate (n=1.474), polytetradecyl methacrylate (n=1.475), poly-n-propyl methacrylate (n=1.484), poly-3,3,5-trimethylcyclohexyl methacrylate (n=1.484), polyethyl methacrylate (n=1.485), poly-2-nitro-2-methylpropyl methacrylate (n=1.487), poly-1,1-diethylpropyl methacrylate (n=1.489) and polymethyl methacrylate (n=1.489). Two or more of these acrylic polymers may be copolymerized or blended, if desired. Furthermore, a copolymerized resin of an acrylic resin with a polymer other than acryl, such as epoxy acrylate (n=1.48 to 1.60), urethane acrylate (n=1.5 to 1.6), polyether acrylate (n=1.48 to 1.49) and polyester acrylate (n=1.48 to 1.54), may also be used. Above all, urethane acrylate, epoxy acrylate and polyether acrylate are excellent in view of adhesive property. Examples of the epoxy acrylate include (meth)acrylic acid adducts of 1,6-hexanediol diglycidyl ether, neopentyl glycol diglycidyl ether, allyl alcohol diglycidyl ether, resorcinol diglycidyl ether, adipic acid diglycidyl ester, phthalic acid diglycidyl ester, polyethylene glycol diglycidyl ether, trimethylolpropane triglycidyl ether, glycerin triglycidyl ether, pentaerythritol tetraglycidyl ether, and sorbitol tetraglycidyl ether. A polymer having a hydroxyl group within its molecule, such as epoxy acrylate, is effective in enhancing the adhesion property. Two or more of these copolymerized resins may be used in combination, if desired. The softening point of the polymer becoming an adhesive is, in view of handleability, preferably 200° C. or lower, more preferably 150° C. or lower. Considering usage of the light diffusing film, the use environment is usually at 80° C. or lower and therefore, the softening temperature of the adhesion layer is particularly preferably from 80° C. to 120° C. in view of processability. On the other hand, the mass average molecular weight (a mass average molecular weight measured using a calibration curve of standard polystyrene by gel permeation chromatography; hereinafter the same) of the polymer used is preferably 500 or more. When the molecular weight is 500 or more, the cohesive force of the adhesive composition is sufficiently brought out and the adhesion to an adherend can be unfailingly obtained. In the adhesive for use in the present invention, additives such as diluent, plasticizer, antioxidant, filler, colorant, ultraviolet absorbent and tackifier may be blended, if desired. The thickness of the adhesion layer is not particularly limited and may be suitably selected in accordance with the intended use. It is, however, preferably, in dry film thickness, 10 μm or less, more preferably 5 μm or less.

The material of the adhesive is not particularly limited and may be suitably selected in accordance with the intended use. As for the material of the adhesive, bisphenol A-type epoxy resin, bisphenol F-type epoxy resin, tetrahydroxy-phenylmethane-type epoxy resin, novolak-type epoxy resin, resorcin-type epoxy resin, polyalcohol.polyglycol-type epoxy resin, polyolefin-type epoxy resin, and epoxy resin such as alicyclic or halogenated bisphenol, may be used (all have a refractive index of 1.55 to 1.60). Examples of the material other than epoxy resin include natural rubber (n=1.52), (di)enes such as polyisoprene (n=1.521), poly-1,2-butadiene (n=1.50), polyisobutene (n=1.505 to 1.51), polybutene (n=1.5125), poly-2-heptyl-1,3-butadiene (n=1.50), poly-2-tert-butyl-1,3-butadiene (n=1.506) and poly-1,3-butadiene (n=1.515), polyethers such as polyoxyethylene (n=1.4563), polyoxypropylene (n=1.4495), polyvinyl ethyl ether (n=1.454), polyvinyl hexyl ether (n=1.4591) and polyvinyl butyl ether (n=1.4563), polyesters such as polyvinyl acetate (n=1.4665) and polyvinyl propionate (n=1.4665), polyurethane (n=1.5 to 1.6), ethyl cellulose (n=1.479), polyvinyl chloride (n=1.54 to 1.55), polyacrylonitrile (n=1.52), polymethacrylonitrile (n=1.52), polysulfone (n=1.633), polysulfide (n=1.6), and phenoxy resin (n=1.5 to 1.6). These materials have a suitable visible light transmittance.

Besides the above resins, there may be used poly(meth)acrylic acid esters such as polyethyl acrylate (n=1.4685), polybutyl acrylate (n=1.466), poly-2-ethylhexyl acrylate (n=1.463), poly-tert-butyl acrylate (n=1.4638), poly-3-ethoxypropyl acrylate (n=1.465), polyoxycarbonyl tetramethacrylate (n=1.465), polymethyl acrylate (n=1.472 to 1.480), polyisopropyl methacrylate (n=1.4728), polydodecyl methacrylate (n=1.474), polytetradecyl methacrylate (n=1.4746), poly-n-propyl methacrylate (n=1.484), poly-3,3,5-trimethylcyclohexyl methacrylate (n=1.484), polyethyl methacrylate (n=1.485), poly-2-nitro-2-methylpropyl methacrylate (n=1.4868), polytetracarbanyl methacrylate (n=1.4889), poly-1,1-diethylpropyl methacrylate (n=1.4889) and polymethyl methacrylate (n=1.4893). Two or more of these acrylic polymers may be copolymerized or blended, if desired.

Furthermore, a copolymerized resin of an acrylic resin with a polymer other than acryl, such as epoxy acrylate, urethane acrylate, polyether acrylate and polyester acrylate, may also be used. Above all, epoxy acrylate and polyether acrylate are excellent in view of adhesion property.

The epoxy acrylate is not particularly limited and may be suitably selected in accordance with the intended use. Examples of the epoxy acrylate include (meth)acrylic acid adducts of 1,6-hexanediol diglycidyl ether, neopentyl glycol diglycidyl ether, allyl alcohol diglycidyl ether, resorcinol diglycidyl ether, adipic acid diglycidyl ester, phthalic acid diglycidyl ester, polyethylene glycol diglycidyl ether, trimethylolpropane triglycidyl ether, glycerin triglycidyl ether, pentaerythritol tetraglycidyl ether, and sorbitol tetraglycidyl ether. The epoxy acrylate has a hydroxyl group within its molecule and therefore, is effective in enhancing the adhesion property. Two or more of these copolymerized resins may be used in combination, if desired. The mass average molecular weight of the polymer used to become the main component of the adhesive is 1,000 or more. When the molecular weight is 1,000 or more, the cohesive force of the composition is sufficiently brought out and the adhesion to an adherend can be unfailingly obtained.

In addition to these materials, the adhesive may contain, for example, a monomer having a high refractive index and/or a metal oxide ultrafine particle having a high refractive index.

The monomer having a high refractive index is not particularly limited and may be suitably selected in accordance with the intended use. Examples thereof include bis(4-methacryloylthiophenyl)sulfide, vinylnaphthalene, vinylphenyl sulfide and 4-methacryloxyphenyl-4′-methoxyphenyl thioether.

The metal oxide ultrafine particle having a high refractive index is not particularly limited and may be suitably selected in accordance with the intended use. It is preferred to contain fine particles having a particle diameter of 100 nm or smaller, preferably 50 nm or smaller, and containing an oxide of at least one metal selected from the group consisting of zirconium (Zr), titanium (Ti), alumina (Al), indium (In), zinc (Zn), tin (Sn) and antimony (Sb). Specific examples thereof include ZrO₂, TiO₂, Al₂O₃, In₂O₃, ZnO, SnO₂, Sb₂O₃ and ITO. In particular, the adhesion layer preferably contains at least one inorganic fine particle selected from the group consisting of ZrO₂, TiO₂, SnO₂ and ZnO and in this case, the adhesion layer becomes a high refractive index layer. Among these, ZrO₂ is more preferred.

The amount of the monomer or metal oxide ultrafine particle having a high refractive index added is preferably from 10% by mass to 90% by mass, more preferably from 20% by mass to 80% by mass, based on the total mass of the matrix material 31.

A curing agent (crosslinking agent) may also be used in the adhesive, and examples of the crosslinking agent which can be used include amines such as triethylenetetramine, xylenediamine and diaminodiphenylmethane, acid anhydrides such as phthalic anhydride, maleic anhydride, dodecyisuccinic anhydride, pyromellitic anhydride and benzophenonetetracarboxylic anhydride, diaminodiphenylsulfone, tris(dimethylaminomethyl)phenol, polyamide resin, dicyandiamide, and ethylmethylimidazole. These crosslinking agents may be used alone or in combination in the form of a mixture. The amount of the crosslinking agent added is 0.1 parts by mass to 50 parts by mass, preferably 1 part by mass to 30 parts by mass, per 100 parts by mass of the above-described polymer. If the amount added is less than 0.1 parts by mass, the curing becomes insufficient, whereas if it exceeds 50 parts by mass, excessive crosslinking results and adversely affects the adhesion property. In the resin composition of the adhesive for use in the present invention, additives such as diluent, plasticizer, antioxidant, filler, colorant and tackifier may be blended, if desired. The resin composition of the adhesive is applied to partially or entirely cover the substrate of a constituent material where a geometric pattern drawn with an electrically conductive material is provided on the surface of a transparent plastic substrate, and through drying of the solvent and curing under heating, the adhesive film according to the present invention is obtained. This adhesive film having electromagnetic wave shielding property and transparency is directly attached to a display such as CRT, PDP, liquid crystal and EL by the adhesive of the adhesive film, or attached to a plate or sheet such as acrylic plate or glass plate and then used for a display.

The adhesive is preferably transparent. Specifically, the total light transmittance is preferably 70% or higher, more preferably 80% or higher, and particularly preferably from 85% to 92%. Furthermore, the adhesive preferably has a low haze level. Specifically, the haze level is preferably from 0% to 3%, more preferably from 0% to 1.5%. The adhesive for use in the present invention is preferably colorless so as not to change the display color inherent in the display. However, even if the resin itself is colored, when the thickness of the adhesive is thin, the adhesive can be regarded as being substantially colorless. Also, in the case of intentionally coloring the adhesive, as described below, the transmittance and haze level are not in the ranges above.

The adhesive having the above-described properties is not particularly limited and may be suitably selected in accordance with the intended use. Examples thereof include acrylic resins, α-olefin resins, vinyl acetate-based resins, acrylic copolymer-based resins, urethane-based resins, epoxy-based resins, vinylidene chloride-based resins, vinyl chloride-based resins, ethylene-vinyl acetate-based resins, polyamide-based resins and polyester-based resins. Among these, acrylic resins are preferred. Even when the same resin is used, the self-adhesion property can be enhanced by such a method as that, at the synthesis of the adhesive by a polymerization method, the amount of the crosslinking agent added is decreased, a tackifier is added, or the terminal group of the molecule is changed. Also, even with the use of the same adhesive, the adhesion can be enhanced by modifying the surface to which the adhesive is to be adhered, that is, by applying surface modification to the transparent plastic film or glass plate. Examples of the surface modification method include a physical method such as corona discharge treatment and plasma glow treatment, and a method of forming an underlying layer for enhancing the adhesion.

The thickness of the adhesive is not particularly limited and may be suitably selected in accordance with the intended use. In view of transparency, colorlessness and handleability, the thickness of the adhesive is, however, preferably about 1 μm to about 50 μm, more preferably about 1 μm to 20 μm. In the case where a change in the display color of the display itself is not caused and the transparency is in the range above, the thickness of the adhesive may exceed the above-described range.

### EXAMPLES

Hereinafter, the present invention will be further described in detail with reference to Examples and Comparative Examples, however, the present invention shall not be construed as being limited thereto.

### Comparative Example 1

### Production of Optical Member 1

### <<Production of Transparent Substrate Provided With Barrier Layer>>

Over an entire surface of a transparent substrate having a thickness of 100 μm and composed of polyethylene naphthalate (PEN), a SiN film and a SiON film were deposited in this order by a CVD method to form a barrier layer having a thickness of 500 nm, thereby producing a transparent PEN substrate provided with a barrier layer.

### <<Production of Color Filter>>

Firstly, curable compositions described below were each dispersed for approximately 16 hours with a sand mill to produce a green curable composition, a red curable composition and a blue curable composition.

### <<<Green Curable Composition>>>

benzyl methacrylate/methacrylic acid copolymer . . . 80 parts by mass (mass average molecular weight: 30,000, acid value: 150)
propylene glycol monomethyl ether acetate . . . 500 parts by mass
copper phthalocyanine pigment . . . 33 parts by mass
C.I. Pigment Yellow 185 . . . 67 parts by mass

### <<<Red Curable Composition>>>

benzyl methacrylate/methacrylic acid copolymer . . . 80 parts by mass (mass average molecular weight: 30,000, acid value: 150)
propylene glycol monomethyl ether acetate . . . 500 parts by mass
Pigment Red 254 . . . 50 parts by mass
Pigment Red PR 177 . . . 50 parts by mass

### <<<Blue Curable Composition>>>

benzyl methacrylate/methacrylic acid copolymer . . . 80 parts by mass (mass average molecular weight: 30,000, acid value: 150)
propylene glycol monomethyl ether acetate . . . 500 parts by mass
Pigment Blue 15:6 . . . 95 parts by mass
Pigment Violet 23 . . . 5 parts by mass

Next, to each of the green curable composition, red curable composition and blue curable composition thus prepared, the following components were added.
dipentaerythritol hexaacrylate (DPHA) . . . 80 parts by mass
TiO₂ (light scattering particle, average particle diameter (average diameter) 0.30 μm refractive index: 2.54) . . . 40 parts by mass
4-[o-bromo-p-N,N-di(ethoxycarbonyl)aminophenyl]2,6-di(trichloromethyl)-s-triazine . . . 5 parts by mass
7-[{4-chloro-6-(diethylamino)-S-triazine-2-yl}amino]-3-phenylcoumarin . . . 2 parts by mass
hydroquinone monomethyl ether . . . 0.01 parts by mass
propylene glycol monomethyl ether acetate . . . 500 parts by mass

Each of the above components were uniformly mixed and filtered through a filter having pore size of 5 μm to obtain three-color curable compositions. Among these, the green curable composition was applied onto the barrier layer of the transparent PEN substrate provided with a barrier layer by a spin coater so as to have a dry film thickness of 2.50 μm, and dried at 120° C. for 2 minutes to thereby form a green uniform coating film. Note that the barrier layer is a layer of 500 nm in thickness, composed of a SiN film and a SiON film functioning to prevent permeation of oxygen and moisture in the air.

Next, the coating film was irradiated with light having a wavelength of 365 nm, through a mask of 100 μm, by an exposing device, at an exposure dose of 300 mJ/cm². After the irradiation, the coating film was developed using a 10% CD (produced by Fuji Film Arch Co., Ltd.) developer at 26° C. for 60 seconds. Subsequently, the coating film was rinsed with running water for 20 seconds, dried using an air knife, and then heat treated at 180° C. for 30 minutes to form a green pattern image (green pixels). This procedure was performed in a same manner for the red curable composition and blue curable composition, with respect to a same glass substrate to form a red pattern image (red pixels) and a blue pattern image (blue pixels) in this order, thereby obtaining a color filter (light diffusion layer) having a dry film thickness of 2.5 μm.

The indices of the green pixels, red pixels and blue pixels (cured products of the curable compositions) containing no TiO₂ light scattering particle measured at each light transmitting wavelength of 550 nm, 630 nm, and 450 nm, were 1.50, 1.51 and 1.49, respectively. In Example 1, Optical Member 1 was produced in which a color filter (light diffusion layer) was formed by curing the curable compositions each containing colorants and a light scattering particle.

### Example 1

### Production of Optical Member 2

### <<Preparation of Low Refractive Index Layer Coating Liquid>>

Into 93 parts by mass of a thermally crosslinkable fluorine-containing polymer having a refractive index of 1.42 (JN-7228, produced by JSR Corporation), 8 parts by mass of MEK-ST (methylethylketone (MEK) dispersed product of SiO₂ sol having an average particle diameter of 10 nm to 20 nm and a solid content concentration of 30 parts by mass, produced by Nissan Chemical Industries Ltd.), and 100 parts by mass of methylethylketone were added, stirred and then filtered through a polypropylene filter having a pore size of 1 μm, thereby preparing a low-refractive-index layer coating liquid.

The low-refractive-index layer coating liquid thus prepared was applied onto the barrier layer of the transparent PEN substrate provided with a barrier layer produced in Comparative Example 1 using a bar coater, dried at 80° C., and further thermally crosslinked at 120° C. for 10 minutes to form a low-refractive-index layer (refractive index: 1.43) having a thickness of 1.2 μm. Subsequently, over the low-refractive-index layer, the green curable composition, red curable composition, and blue curable composition produced in Comparative Example 1 were used to form a color filter (light diffusion layer) in the same manner as in Comparative Example 1, and thus Optical Member 2 was produced. The dry film thickness of the color filter (light diffusion layer) in Optical Member 2 was 2.5 μm. Note that the barrier layer is a layer of 500 nm in thickness, composed of a SiN film and a SiON film functioning to prevent permeation of oxygen and moisture in the air.

### Examples 2 to 14 and Comparative Example 2

Optical Members 3 to 16 were produced in the same manner as in Example 1 except that the material of the light scattering particle constituting Optical Member 2, the average particle diameter of the light scattering particle, and the thicknesses of the light diffusion layer and low-refractive-index layer (refractive index: 1.43) were changed as shown in Table 1. In the column of “Type of light scattering particle” in Table 1, Particle 1 is a TiO₂ particle (refractive index: 2.54), and Particle 2 represents benzoguanamine beads (EPOSTAR MS, produced by Nippon Shokubai Co., Ltd., refractive index: 1.66).

### Comparative Example 3

### Production of Optical Member 17

Into a four-necked flask equipped with a stirrer, a reflux condenser, a thermometer and a nitrogen inlet line for producing an acrylic copolymer emulsion, 30 parts by mass of water, and 0.1 parts by mass of ammonium persulfate were charged, and the temperature thereof was raised, in a nitrogen purge, to 70° C., and an emulsion monomer mixture B containing the following composition was dropped thereinto over 4 hours. After completion of the dropping, the reaction product was further reacted for 3 hours to thereby obtain an acrylic copolymer emulsion (light diffusion layer coating liquid) having a solid content of 50%.

### <<Composition of Emulsion Monomer Mixture B>>

n-butyl acrylate . . . 49.5 parts by mass
2-ethylhexyl acrylate . . . 50 parts by mass
acrylic acid . . . 0.5 parts by mass
water . . . 70 parts by mass
dodecylmercaptan . . . 0.05 parts by mass
sodium lauryl sulfate . . . 0.5 parts by mass
nonionic emulsifier . . . 1.0 part by mass (trade name: “NOIGEN EA140”, produced by DAI-ICHI KOGYO SEIYAKU CO., LTD.)
inorganic fine particle TiO₂ . . . 100.0 parts by mass (light scattering particle, average particle diameter: 0.30 μm, refractive index: 2.54)
dispersant . . . 0.1 parts by mass (trade name: “NEOGEN P”, produced by DAI-ICHI KOGYO SEIYAKU CO., LTD.)
antifoaming agent . . . 0.1 parts by mass (trade name: “SN DEFOAMER”, produced by San Nopco Limited)

Here, in the optical members containing no light scattering particle of the emulsion monomer mixture B, a matrix material for light diffusion layer was formed. In order to measure the refractive index of the matrix material, an emulsion monomer mixture B′ was prepared in which TiO₂ particle was not blended, and the emulsion monomer mixture B′ was dropped and reacted in the same manner as described above to prepare an acrylic copolymer emulsion. This acrylic copolymer emulsion was applied onto a glass substrate to form a matrix material. A refractive index of the matrix material was measured using a reflection spectral film thickness meter, and was found to be 1.45.

The light diffusion layer coating liquid thus prepared was applied onto the barrier layer of the transparent PEN substrate provided with a barrier layer produced in Comparative Example 1 using a spin coater so as to have a dry film thickness of 2.5 μm and dried at 180° C. for 60 minutes to form a light diffusion layer, and thus Optical Member 17 was produced. Note that the barrier layer is a layer of 500 nm in thickness, composed of a SiN film and a SiON film functioning to prevent permeation of oxygen and moisture in the air.

### Examples 15 and 16, Comparative Example 4

Optical Members 18 to 20 were produced in the same manner as in Comparative Example 3, except that instead of forming the light diffusion layer on the barrier layer of the transparent PEN substrate provided with a barrier layer, the low-refractive-index layer coating liquid produced in Example 1 was applied using a bar coater, dried at 80° C., and further thermally crosslinked at 120° C. for 10 minutes to form a low-refractive-index layer (refractive index: 1.43) having a thickness shown in Table 1, and a light diffusion layer was formed on the thus formed low-refractive-index layer.

### Comparative Example 5

Optical Member 21 was produced in the same manner as in Example 1 so that a low-refractive-index layer (refractive index: 1.43) and a color filter (light diffusion layer) were formed therein, except that instead of using the transparent PEN substrate provided with a barrier layer, a transparent substrate having a thickness of 100 μm, composed of polyethylene naphthalate (PEN) and provided with no barrier layer was used.

TABLE 1

| | | | | | | Light |
|---|---|---|---|---|---|---|
| | | Low-refractive- | | Light scattering particle | | diffusion |
| | | index layer | | | Average | layer |
| | | Provided/ | Thickness | | particle | Thickness |
| | | Not provided | (μm) | Type | diameter (μm) | (μm) |
| Comp. Example 1 | Optical Member 1 | Not provided | — | Particle 1 | 0.3 | 2.5 |
| Example 1 | Optical Member 2 | Provided | 1.2 | Particle 1 | 0.3 | 2.5 |
| Example 2 | Optical Member 3 | Provided | 1.2 | Particle 1 | 0.3 | 5.0 |
| Example 3 | Optical Member 4 | Provided | 1.2 | Particle 1 | 0.3 | 10.0 |
| Example 4 | Optical Member 5 | Provided | 1.2 | Particle 1 | 0.3 | 1.0 |
| Example 5 | Optical Member 6 | Provided | 1.2 | Particle 1 | 2.5 | 2.5 |
| Example 6 | Optical Member 7 | Provided | 1.2 | Particle 1 | 2.5 | 5.0 |
| Example 7 | Optical Member 8 | Provided | 1.2 | Particle 1 | 2.5 | 10.0 |
| Example 8 | Optical Member 9 | Provided | 1.2 | Particle 1 | 2.5 | 1.0 |
| Example 9 | Optical Member 10 | Provided | 1.2 | Particle 2 | 0.3 | 2.5 |
| Example 10 | Optical Member 11 | Provided | 1.2 | Particle 2 | 0.3 | 5.0 |
| Example 11 | Optical Member 12 | Provided | 1.2 | Particle 2 | 0.3 | 10.0 |
| Example 12 | Optical Member 13 | Provided | 1.2 | Particle 2 | 0.3 | 1.0 |
| Comp. Example 2 | Optical Member 14 | Provided | 1.0 | Particle 1 | 0.3 | 2.5 |
| Example 13 | Optical Member 15 | Provided | 2.0 | Particle 1 | 0.3 | 2.5 |
| Example 14 | Optical Member 16 | Provided | 3.0 | Particle 1 | 0.3 | 2.5 |
| Comp. Example 3 | Optical Member 17 | Not provided | — | Particle 1 | 0.3 | 2.5 |
| Comp. Example 4 | Optical Member 18 | Provided | 1.0 | Particle 1 | 0.3 | 2.5 |
| Example 15 | Optical Member 19 | Provided | 1.2 | Particle 1 | 0.3 | 2.5 |
| Example 16 | Optical Member 20 | Provided | 3.0 | Particle 1 | 0.3 | 2.5 |
| Comp. Example 5 | Optical Member 21 | Provided | 1.2 | Particle 1 | 0.3 | 2.5 |

### <Measurement of Water Vapor Permeability by MOCON Method>

The water vapor permeability of Optical Member 2 of Example 1 and Optical Member 21 of Comparative Example 5 was measured at 40° C./relative humidity 90%, using a water vapor permeation tester (PERMATRAN-W3/31, manufactured by MOCON Inc.). The detection limit value of this measurement is 0.005 g/m²/day.

The water vapor permeability of Optical Member 2 of Example 1 was equal to or lower than the detection limit value, i.e., 0.005 g/m²/day.

The water vapor permeability of Optical Member 21 of Comparative Example 5 was 1.4 g/m²/day.

The above results demonstrated that Optical Member 2 composed of a transparent PEN substrate provided with a barrier layer is superior in water vapor permeability to Optical Member 21 composed of a transparent substrate provided with no barrier layer.

Each of the Optical Members 1 to 21 (a light diffusion layer 170, a barrier layer 150, and transparent substrate 160 (FIG. 3)) produced in Examples 1 to 16 and Comparative Examples 1 to 5 was jointed, via an adhesion layer 180 (FIG. 3), to an organic EL device (a product illustrated in FIG. 3 where on a TFT substrate 110, a lower electrode 120 was formed, and an organic EL layer 130 and an upper electrode 140 were formed in this order on the lower electrode 120) to thereby producing top-emission type organic EL display devices.

The configuration of the organic EL display device is illustrated in FIG. 3. In FIG. 3, on the TFT substrate 110, the lower electrode 120 is formed, and over the lower electrode 120, the organic EL layer 130, the upper electrode 140, the adhesion layer 180, the light diffusion layer 170, and the transparent substrate 160 having a surface on which a barrier layer 150 is deposited, are formed in this order.

The organic EL device and the adhesion layer were produced in the following manners.

### <Production of Organic EL Device>

Firstly, on an insulating substrate (thickness: 700 μm) made of a glass substrate, TFT (thickness: 40 nm) made of polycrystalline silicon was formed by CVD method, via a buffer layer (thickness: 200 nm) formed of a SiO₂ film using CVD method. Next, an interlayer insulating film layer (thickness: 400 nm) formed on a SiN film was deposited on the entire surface of the buffer layer, and then contact holes (diameter: 10 nm) each reaching the source/drain regions were formed through the SiO₂ film and SiN film by a common photo-etching process.

Next, a Ti/Al/Ti-multilayer electrically conductive layer (thickness: 400 nm) was deposited on the entire surface of the laminate, and patterning was performed thereon by a common photo-etching process so as to form a source electrode extending along on the TFT portion and to form a drain electrode.

Note that the source electrode is branched into four branched lines from a common source line.

Next, a photosensitive resin made of an acrylic resin was applied onto the entire surface of the laminate by a spin coating method to form an interlayer insulating film (thickness: 2.0 μm). The laminate was exposed to light using the interlayer insulating film as a mask, and then developed using an alkali developer to form contact holes corresponding to the branched lines of the source electrode.

Next, an Al film (thickness: 200 nm) was deposited on the entire surface of the laminated by a sputtering method, followed by patterning in a predetermined pattern by a common photo-etching process, thereby forming split lower electrodes composed of Al and connected to the branched lines of the source electrode through the contact holes.

Next, an organic EL layer (thickness: 86 nm), which was composed of 4,4′-bis((N-(1-naphthyl)-N-phenyl-amino-)biphenyl(α-NPD)(a hole transporting layer; thickness: 40 nm)/tris(2-phenylpyridine) iridium (III) (Ir(ppy)₃)+4,4′-N,N′-dicarbazole-biphenyl (CBP) (a light emitting layer; thickness: 20 nm)/2,9-dimethyl-4,7-diphenyl-1,10-phenanthroline (BCP) (hole blocking layer; thickness: 6 nm)/tris(8-hydroxyqunolinato)aluminum (III) (Alq₃) (an electron transporting layer; thickness: 20 nm), was formed (see Applied Physics Letters 1999, vol. 74, p. 442) using a mask evaporation method so as to cover the split lower electrodes which were exposed out at a bottom of the pixel opening portion, and then an Al film having a thickness of 10 nm and a ITO film having a thickness of 30 nm were formed in this order so as to cover the organic EL layer and form common upper electrodes, using the mask evaporation method again, whereby regions corresponding to each of the split lower electrodes were made to be split image elements.

### <Production of Adhesion Layer>

Zirconium ultrafine particle (10 parts by mass) was incorporated into 90 parts by mass of transparent adhesive composed of an acrylic acid ester polymer to obtain a transparent adhesion layer 180 having a refractive index of 1.81 and a dry film thickness of 3.0 μm.

The organic EL display device thus produced was subjected to the following measurement of luminance and evaluation of image blur at 25° C. and a relative humidity of 50%.

### <Measurement of Luminance>

An image was displayed on the organic EL display device, and a luminance angle distribution was measured using an EZ CONTRAST 160D manufactured by ELDIM. From this measured value, a total amount of light emitted was calculated, and a percentage of change in total amount of light emitted between the organic EL display device where no optical member was used and the organic EL display device using an optical member was determined as an increase rate of light extraction. The results are shown in Table 2.

### <Evaluation of Image Blur>

The evaluation of image blur was carried out using a pair of EL elements having a light emitting size of 200×200 μm² and a gap therebetween of 50 μm (FIG. 4).

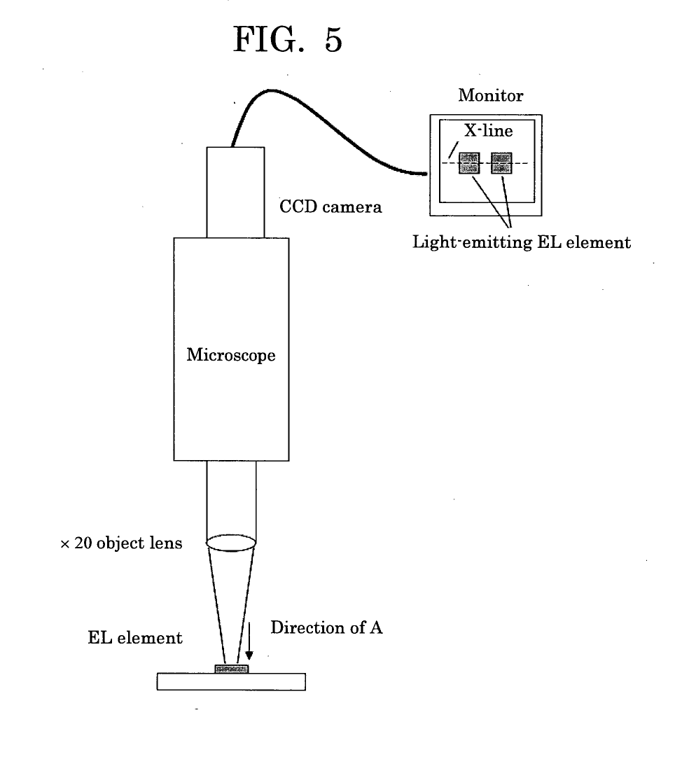

The pair of EL elements were placed, in a turned on state, under a microscope, and the light emitting image was photographed by a CCD (FIG. 5).

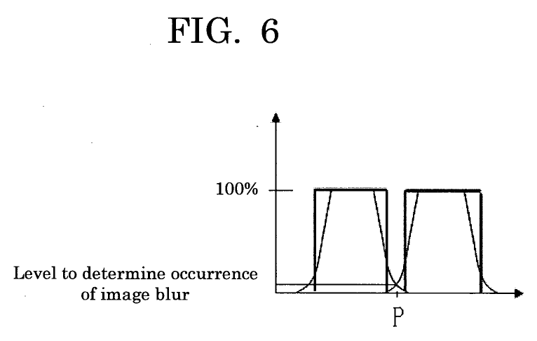

As for the obtained light emitting pattern image, an amount of luminescence on the X line was taken, in several lines, into the CCD, followed by data processing for averaging and graphing (FIG. 6).

In the graph of FIG. 6, in the case where the level to determine the occurrence of image blur at a portion (P indicated in FIG. 6) corresponding to a center in the gap between light emitting patterns is equal to or more than 0% and less than 5% with respect to a peak (level of 100%) was graded as “A”; in the case of the level being equal to or more than 5% and less than 20% was graded as “B”; and in the case of the level being equal to or less than 20% was graded as “C”. The evaluation results are shown in Table 2.

TABLE 2

| | | Increase | | | | |
|---|---|---|---|---|---|---|
| | | rate of light | | | | |
| | | extraction/% | | | | |
| | | B | G | R | Image Blur | Evaluation |
| Comp. | Optical Member 1 | −3 | −4 | −3 | C | Poor |
| Example 1 | | | | | | |
| Example 1 | Optical Member 2 | 30 | 28 | 27 | A | Excellent |
| Example 2 | Optical Member 3 | 26 | 24 | 22 | A | Excellent |
| Example 3 | Optical Member 4 | 22 | 20 | 21 | A | Excellent |
| Example 4 | Optical Member 5 | 18 | 16 | 17 | B | Good |
| Example 5 | Optical Member 6 | 14 | 13 | 13 | B | Good |
| Example 6 | Optical Member 7 | 13 | 13 | 12 | B | Good |
| Example 7 | Optical Member 8 | 11 | 10 | 10 | B | Good |
| Example 8 | Optical Member 9 | 10 | 9 | 9 | B | Good |
| Example 9 | Optical Member 10 | 16 | 17 | 15 | B | Good |
| Example | Optical Member 11 | 13 | 14 | 13 | B | Good |
| 10 | | | | | | |
| Example | Optical Member 12 | 11 | 12 | 10 | B | Good |
| 11 | | | | | | |
| Example | Optical Member 13 | 9 | 10 | 10 | B | Good |
| 12 | | | | | | |
| Comp. | Optical Member 14 | 2 | 3 | 3 | C | Poor |
| Example 2 | | | | | | |
| Example | Optical Member 15 | 35 | 32 | 33 | A | Excellent |
| 13 | | | | | | |
| Example | Optical Member 16 | 22 | 22 | 21 | A | Excellent |
| 14 | | | | | | |
| Comp. | Optical Member 17 | −5 | −7 | −5 | C | Poor |
| Example 3 | | | | | | |
| Comp. | Optical Member 18 | 3 | 4 | 3 | C | Poor |
| Example 4 | | | | | | |
| Example | Optical Member 19 | 20 | 19 | 17 | A | Excellent |
| 15 | | | | | | |
| Example | Optical Member 20 | 11 | 9 | 10 | A | Excellent |
| 16 | | | | | | |
| Comp. | Optical Member 21 | 25 | 23 | 23 | A | Excellent |
| Example 5 | | | | | | |

The results shown in Table 2 demonstrated that by providing an organic EL display device with an optical member where a low-refractive-index layer having a thickness of 1.2 μm or more is formed, it is possible to obtain an organic electroluminescence display device capable of improving light extraction efficiency and reducing image blurring.

### INDUSTRIAL APPLICABILITY

Since the optical member of the present invention is capable of improving light extraction efficiency of an organic electroluminescence display device and reducing image blurring, it is suitably used in production of an optical electroluminescence display device.

### REFERENCE SIGNS LIST

1 TFT substrate
2 back surface electrode
3 organic layer
4 transparent electrode
5 transparent substrate
11 optical member
20 transparent substrate provided with a barrier layer
30 light diffusion layer
31 matrix material
41 light scattering particle
42 colorant
50 low-refractive-index layer
100 organic EL display device
110 TFT substrate
120 lower electrode
130 organic EL layer
140 upper electrode
150 barrier layer
160 transparent substrate
170 light diffusion layer
180 adhesion layer

1. An optical member comprising:
a transparent substrate provided with a barrier layer,
a low-refractive-index layer, and
a light diffusion layer,
the transparent substrate, low-refractive-index layer and light diffusion layer being provided in this order,
wherein the light diffusion layer comprises a light scattering particle and a matrix material containing at least a binder resin, the light scattering particle being dispersed in the matrix material,
wherein the low-refractive-index layer has a thickness of 1.2 μm or more, and
wherein the optical member is used in organic electroluminescence display devices.

2. The optical member according to claim 1, wherein the light diffusion layer further comprises a colorant and functions as a color filter.

3. The optical member according to claim 1, wherein the light scattering particle contains at least one inorganic fine particle selected from ZrO₂, TiO₂, ZnO, and SnO₂.

4. The optical member according to claim 1, wherein the light scattering particle has a refractive index of 2.1 or higher, and the matrix material has a refractive index of 1.6 or lower.

5. The optical member according to claim 1, wherein the light scattering particle has an average particle diameter of 2.0 μm or smaller.

6. The optical member according to claim 5, wherein the light scattering particle has an average particle diameter of 0.2 μm to 0.5 μm.

7. The optical member according to claim 1, wherein the light diffusion layer has a thickness of 2.0 μm to 10.0 μm.

8. The optical member according to claim 1, wherein the low-refractive-index layer has a refractive index of 1.45 or lower.

9. The optical member according to claim 8, wherein the low-refractive-index layer contains a hollow silica.

10. An organic electroluminescence display device comprising:
an optical member,
wherein the optical member comprises:
a transparent substrate provided with a barrier layer,
a low-refractive-index layer, and
a light diffusion layer,
the transparent substrate, low-refractive-index layer and light diffusion layer being provided in this order,
wherein the light diffusion layer comprises a light scattering particle and a matrix material containing at least a binder resin, the light scattering particle being dispersed in the matrix material,
wherein the low-refractive-index layer has a thickness of 1.2 μm or more, and
wherein the optical member is used in organic electroluminescence display devices.

11. The organic electroluminescence display device according to claim 10, further comprising an adhesion layer, wherein the adhesion layer has a refractive index of 1.5 to 1.9.

12. The organic electroluminescence display device according to claim 11, wherein the adhesion layer has a refractive index of 1.65 to 1.9.

13. The organic electroluminescence display device according to claim 11, wherein the adhesion layer has a thickness of 10 μm or less.
